(19) United States
(12) Patent Application Publication
(10) Pub. No.: US 2026/0160925 A1
(43) Pub. Date: Jun. 11, 2026

(54) Multilayer Optical Film and Display System

(71) Applicant: 3M INNOVATIVE PROPERTIES COMPANY, St. Paul, MN (US)

(72) Inventors: Adam D. Haag, Woodbury, MN (US); Matthew B. Johnson, Woodbury, MN (US)

(21) Appl. No.: 18/438,736

(22) PCT Filed: Aug. 15, 2022
(86) PCT No.: PCT/IB2022/057629

§ 371 Date: Feb. 12, 2024

Related U.S. Application Data
(60) Provisional application No. 63/260,493, filed on Aug. 23, 2021.

(51) Int. Cl. G02B 1/04; G02B 5/20; G02B 5/26; G02B 27/01

(52) U.S. Cl. CPC G02B 1/04; G02B 5/208; G02B 5/26; G02B 27/0101

(57) ABSTRACT

A multilayer optical film includes a plurality of alternating first and second polymeric layers numbering at least 50 in total. The first and second polymeric layers have respective indices of refraction nx1 and nx2 along a same in-plane first direction, wherein 0.1≤(nx1−nx2)≤0.25 at at least one visible wavelength in a visible wavelength range extending from about 420 nanometres (nm) to about 680 nm. For a substantially normally incident light polarized along the first direction, the plurality of alternating first and second polymeric layers reflects greater than about 80% of the incident light for at least a first wavelength in a first wavelength range extending from about 380 nm to about 680 nm, and has an average optical absorbance of less than about 1% for a second wavelength range extending from about 380 nm to about 400 nm.

### TECHNICAL FIELD

The present disclosure relates, in general, to a multilayer optical film. In particular, the present disclosure relates to a display system including the multilayer optical film.

### BACKGROUND

Conventionally, multilayer optical films are used in automobile applications, such as in heads-up displays (HUDs). The multilayer optical films may be exposed to sunlight for extended periods of time. In some cases, the multilayer optical films may undergo discoloration, such as yellowing, due to exposure to ultraviolet (UV) light present in sunlight.

### SUMMARY

In a first aspect, the present disclosure provides a multilayer optical film including a plurality of alternating first and second polymeric layers numbering at least 50 in total. Each of the first and second polymeric layers has an average thickness of less than about 500 nanometers (nm). The first and second polymeric layers have respective indices of refraction nx1 and nx2 along a same in-plane first direction, wherein 0.1≤(nx1−nx2)≤0.25 at at least one visible wavelength in a visible wavelength range extending from about 420 nm to about 680 nm. For a substantially normally incident light polarized along the first direction, the plurality of alternating first and second polymeric layers reflects greater than about 80% of the incident light for at least a first wavelength in a first wavelength range extending from about 380 nm to about 680 nm. Further, for the substantially normally incident light polarized along the first direction, the plurality of alternating first and second polymeric layers has an average optical absorbance of less than about 1% for a second wavelength range extending from about 380 nm to about 400 nm.

In a second aspect, the present disclosure provides a display system including an extended light source configured to emit a light from an emission surface thereof. The display system further includes the multilayer optical film of the first aspect of the present disclosure disposed on the extended light source.

In a third aspect, the present disclosure provides a display system including an extended light source configured to emit a light from an emission surface thereof. The display system further includes first and second multilayer optical films of the first aspect of the present disclosure disposed on opposite sides of the extended light source, so that the first multilayer optical film generally faces the emission surface, and the second multilayer optical film generally faces away from the emission surface. For the substantially normally incident light polarized along an in-plane second direction orthogonal to the first direction and for the at least the first wavelength in the first wavelength range, the plurality of alternating first and second polymeric layers of the first multilayer optical film transmits greater than about 60% of the incident light. Further, for the substantially normally incident light polarized along the in-plane second direction orthogonal to the first direction and for the at least the first wavelength in the first wavelength range, the plurality of alternating first and second polymeric layers of the second multilayer optical film reflects greater than about 60% of the incident light.

In a fourth aspect, the present disclosure provides a multilayer optical film including a plurality of alternating first and second polymeric layers numbering at least 50 in total. Each of the first and second polymeric layers has an average thickness of less than about 500 nm. The first polymeric layers include a polyethylene terephthalate (PET) and have an index of refraction nx1 greater than an index of refraction nx2 of the second polymeric layers along at least a same in-plane first direction. For a substantially normally incident light polarized along the first direction, the plurality of alternating first and second polymeric layers reflects greater than about 80% of the incident light for at least a first wavelength in a first wavelength range extending from about 380 nm to about 680 nm. Further, for the substantially normally incident light polarized along the first direction, the plurality of alternating first and second polymeric layers has an average optical absorbance of less than about 1% for a second wavelength range extending from about 380 nm to about 400 nm.

### BRIEF DESCRIPTION OF DRAWINGS

Exemplary embodiments disclosed herein is more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labelled with the same number.

FIG. 1A illustrates a detailed schematic sectional view of a multilayer optical film, according to an embodiment of the present disclosure;

FIG. 1B illustrates a plot of a thickness profile of a plurality of alternating first and second polymeric layers of the multilayer optical film of FIG. 1A, according to an embodiment of the present disclosure;

FIGS. 2A and 2B illustrate schematic sectional views of the multilayer optical film showing different incident lights, according to an embodiment of the present disclosure;

FIG. 3A illustrates a plot depicting an optical reflectance versus wavelength of the multilayer optical film, for a substantially normally incident light, according to an embodiment of the present disclosure;

FIG. 3B illustrates a plot depicting a best linear fit to a reflection band edge of the optical reflectance versus wavelength illustrated in FIG. 3A, according to an embodiment of the present disclosure;

FIG. 4A illustrates a plot depicting optical reflectances versus wavelength of different multilayer optical films, for the substantially normally incident light, according to another embodiment of the present disclosure;

FIG. 4B illustrates a plot depicting best linear fits corresponding to reflection band edges of the optical reflectances versus wavelength of the different multilayer optical films illustrated in FIG. 4A, according to an embodiment of the present disclosure;

FIG. 5A illustrates a plot depicting optical reflectances versus wavelength of different multilayer optical films, for an incident light incident at an oblique incident angle, according to another embodiment of the present disclosure;

FIG. 5B illustrates a plot depicting best linear fits corresponding to reflection band edges of the optical reflectances versus wavelength of the different multilayer optical films illustrated in FIG. 5A, according to an embodiment of the present disclosure;

FIG. 6 illustrates another plot depicting optical absorbances versus wavelength of different multilayer optical films, according to an embodiment of the present disclosure;

FIG. 7A illustrates another plot depicting optical reflectances versus wavelength of different multilayer optical films, for the substantially normally incident light, according to another embodiment of the present disclosure;

FIG. 7B illustrates a plot depicting best linear fits corresponding to reflection band edges of the optical reflectances versus wavelength of the different multilayer optical films illustrated in FIG. 7A, according to an embodiment of the present disclosure;

FIG. 8A illustrates another plot depicting an optical reflectance versus wavelength of a multilayer optical film, for the incident light incident at the oblique incident angle, according to another embodiment of the present disclosure;

FIG. 8B illustrates a plot depicting a best linear fit to a reflection band edge of the optical reflectance versus wavelength illustrated in FIG. 8A, according to an embodiment of the present disclosure;

FIG. 9 illustrates another plot depicting optical absorbances versus wavelength of different multilayer optical films, according to an embodiment of the present disclosure;

FIG. 10A illustrates a detailed schematic sectional view of a display system, according to an embodiment of the present disclosure;

FIG. 10B illustrates a detailed schematic sectional view of a display system, according to another embodiment of the present disclosure;

FIG. 11A illustrates a detailed schematic sectional view of a display system, according to another embodiment of the present disclosure;

FIG. 11B illustrates a detailed schematic sectional view of a display system, according to another embodiment of the present disclosure;

FIG. 12A illustrates a schematic side view of an example of a vehicle having a windshield; and

FIG. 12B illustrates a schematic view of an example display system for the windshield of the vehicle of FIG. 12A.

### DETAILED DESCRIPTION

In the following description, reference is made to the accompanying figures that form a part thereof and in which various embodiments are shown by way of illustration. It is to be understood that other embodiments are contemplated and is made without departing from the scope or spirit of the present disclosure. The following detailed description, therefore, is not to be taken in a limiting sense.

In the following disclosure, the following definitions are adopted.

As used herein, all numbers should be considered modified by the term “about”. As used herein, “a,” “an,” “the,” “at least one,” and “one or more” are used interchangeably.

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties).

The term “substantially”, unless otherwise specifically defined, means to a high degree of approximation (e.g., within +/−10% for quantifiable properties) but again without requiring absolute precision or a perfect match.

The term “about”, unless otherwise specifically defined, means to a high degree of approximation (e.g., within +/−5% for quantifiable properties) but again without requiring absolute precision or a perfect match.

As used herein, the terms “first” and “second” are used as identifiers. Therefore, such terms should not be construed as limiting of this disclosure. The terms “first” and “second” when used in conjunction with a feature or an element can be interchanged throughout the embodiments of this disclosure.

As used herein, when a first material is termed as “similar” to a second material, at least 90 weight % of the first and second materials are identical and any variation between the first and second materials comprises less than about 10 weight % of each of the first and second materials.

As used herein, “at least one of A and B” should be understood to mean “only A, only B, or both A and B”.

As used herein, the term “between about”, unless otherwise specifically defined, generally refers to an inclusive or a closed range. For example, if a parameter X is between about A and B, then A≤X≤B.

As used herein, the term “film” generally refers to a material with a very high ratio of length or width to thickness. A film has two major surfaces defined by a length and width. Films typically have good flexibility and can be used for a wide variety of applications, including displays. Films may also be of suitable thickness or material composition, such that they are semi-rigid or rigid. Films described in the present disclosure may be composed of various polymeric materials. Films may be monolayer, multilayer, or blend of different polymers.

As used herein, the term “layer” generally refers to a thickness of material within a film that has a relatively consistent chemical composition. Layers may be of any type of material including polymeric, cellulosic, metallic, or a blend thereof. A given polymeric layer may include a single polymer-type or a blend of polymers, and may be accompanied by additives. A given layer may be combined or connected to other layers to form films. A layer may be either partially or fully continuous as compared to adjacent layers or the film. A given layer may be partially or fully coextensive with adjacent layers. A layer may contain sub-layers.

As used herein, the term “index”, unless otherwise specifically defined, generally refers to a refractive index of a material or a layer. Similarly, the term “indices”, unless otherwise specifically defined, generally refers to refractive indices of multiple materials or layers and/or multiple refractive indices of a single material or layer.

The present disclosure relates to a multilayer optical film and a display system including the multilayer optical film. In some cases, the multilayer optical film may be used in backlights including light emitting diodes (LEDs) which may emit light including UV light. In some cases, the multilayer optical film of the present disclosure may be used in other applications, such as rear-view mirror displays, polarized headlamps, or in HUD dust covers on a dash of the vehicle. In some cases, the display system may be used in a heads-up display (HUD) of a vehicle. The HUD is used to present information to a vehicle passenger without requiring the passenger to look away from surroundings of the vehicle, that can be viewed through a vehicle windshield. HUDs are now increasingly used as a safety feature for vehicles, such as automobiles.

Generally, the HUD includes optical films that substantially reflect light in desired wavelength ranges that are particular to the HUD and transmit light in other wavelength ranges into a heat sink. Some optical films may include reflective polarizers to selectively reflect a light polarized along one direction, while transmitting light polarized along a direction orthogonal to the one direction, and to further transmit the light polarized along the direction orthogonal to the one direction into the heat sink. Such optical films are generally exposed to sunlight for extended periods of time. Conventional optical films may include materials, such as polyethylene naphthalate (PEN) or polymers including naphthalene dicarboxylic acid (NDC), which generally have high birefringence, and may therefore form high contrast reflective polarizers or mirrors having high reflectivity for the light polarized along the one direction. However, such optical films including the materials such as PEN or the polymers including NDC may discolor, specifically, may turn yellow due to prolonged exposure to ultraviolet (UV) light present in the sunlight.

In an aspect, the present disclosure provides a multilayer optical film including a plurality of alternating first and second polymeric layers numbering at least 50 in total. Each of the first and second polymeric layers has an average thickness of less than about 500 nanometers (nm). The first and second polymeric layers have respective indices of refraction nx1 and nx2 along a same in-plane first direction, wherein 0.1≤(nx1−nx2)≤0.25 at at least one visible wavelength in a visible wavelength range extending from about 420 nm to about 680 nm. For a substantially normally incident light polarized along the first direction, the plurality of alternating first and second polymeric layers reflects greater than about 80% of the incident light for at least a first wavelength in a first wavelength range extending from about 380 nm to about 680 nm. Further, for the substantially normally incident light polarized along the first direction, the plurality of alternating first and second polymeric layers has an average optical absorbance of less than about 1% for a second wavelength range extending from about 380 nm to about 400 nm.

The multilayer optical film of the present disclosure may provide a high reflectance (greater than about 80%) for the incident light for at least the first wavelength in the first wavelength range. In other words, the multilayer optical film may provide a high reflectance (greater than about 80%) for the incident light of a desired wavelength in the first wavelength range.

As discussed above, this is generally achieved by optical films including materials, such as PEN or the polymers including NDC, which may have high birefringence. However, they tend to turn yellow due to prolonged exposure to UV light present in sunlight.

The multilayer optical film of the present disclosure may provide the high reflectance (greater than about 80%) for the incident light for the at least the first wavelength in the first wavelength range without undergoing significant discoloring or yellowing due to prolonged exposure to UV light present in sunlight. This may be achieved by optimizing refractive indices for the first and second layers to provide a suitable birefringence. Further, in some cases, the multilayer optical film may include materials, such as polyethylene terephthalate (PET) that may not significantly discolor due to prolonged exposure to UV light present in sunlight. Thus, such optical films may undergo significantly less color change due to prolonged exposure to UV light present in sunlight than conventional optical films including PEN or the polymers including NDC.

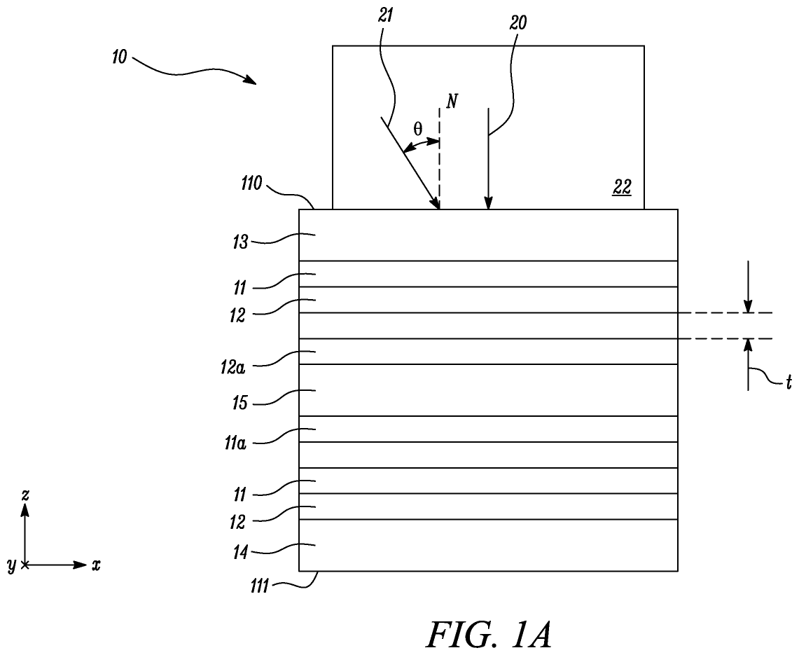

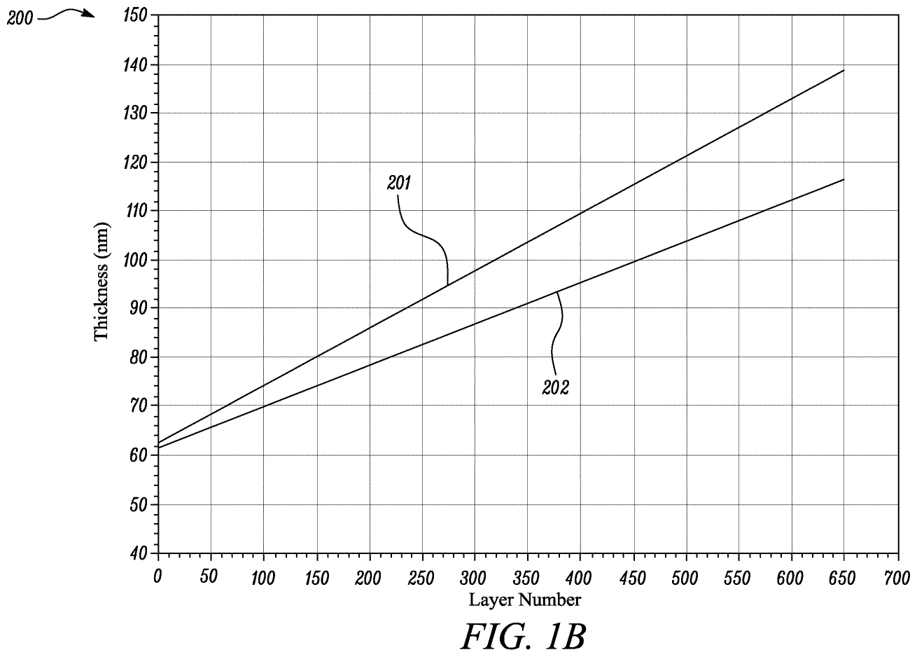

Referring now to figures, FIG. 1A illustrates a detailed schematic sectional view of a multilayer optical film 10, according to an embodiment of the present disclosure. The multilayer optical film 10 defines mutually orthogonal x-, y-, and z-axes. The x- and y-axes correspond to in-plane axes of the multilayer optical film 10, while the z-axis is a transverse axis disposed along a thickness of the multilayer optical film 10. In other words, the x- and y-axes are disposed along a plane (i.e., the x-y plane) of the multilayer optical film 10, and the z-axis is perpendicular to the plane of the multilayer optical film 10. In some embodiments, the multilayer optical film 10 further defines an in-plane (i.e., the x-y plane) first direction, an in-plane second direction orthogonal to the first direction, and an out-of-plane direction orthogonal to the first direction. In the illustrated embodiment of FIG. 1A, the in-plane first direction is along the x-axis, the in-plane second direction is along the y-axis, and the out-of-plane direction is along the z-axis.

In some embodiments, the multilayer optical film 10 includes opposing first and second major surfaces 110, 111. In some embodiments, the first and second major surfaces 110, 111 of the multilayer optical film 10 are exposed to an external environment. In such embodiments, the first and second major surfaces 110, 111 of the multilayer optical film 10 may form first and second interfaces with the external environment, respectively. In some embodiments, the external environment may include air.

The multilayer optical film 10 includes a plurality of alternating first and second polymeric layers 11, 12. The plurality of alternating first and second polymeric layers 11, 12, may be interchangeably referred to as “the plurality of polymeric layers 11, 12”, or “the first and second polymeric layers 11, 12”. In some embodiments, the plurality of alternating first and second polymeric layers 11, 12 are disposed adjacent to each other along the z-axis. The plurality of alternating first and second polymeric layers 11, 12 number at least 50 in total. In some embodiments, the plurality of alternating first and second polymeric layers 11, 12 number at least 100, at least 200, at least 300, at least 400, at least 500, or at least 600 in total.

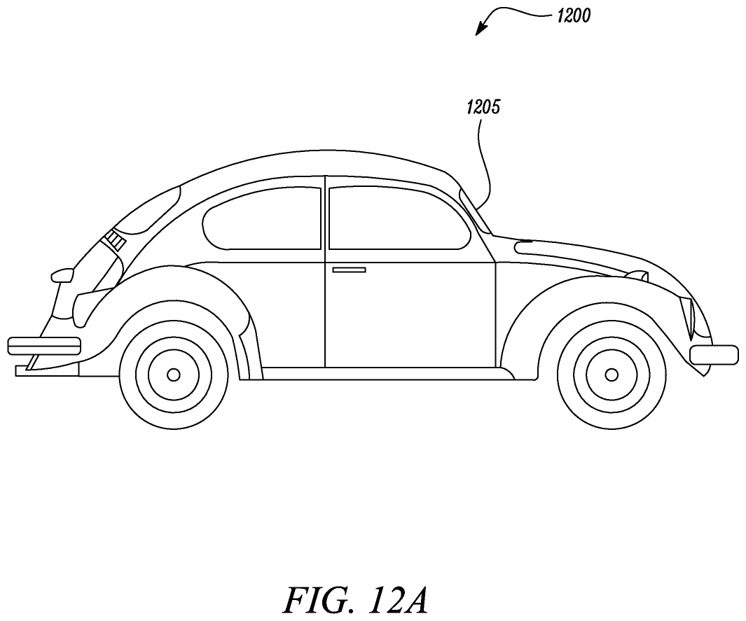

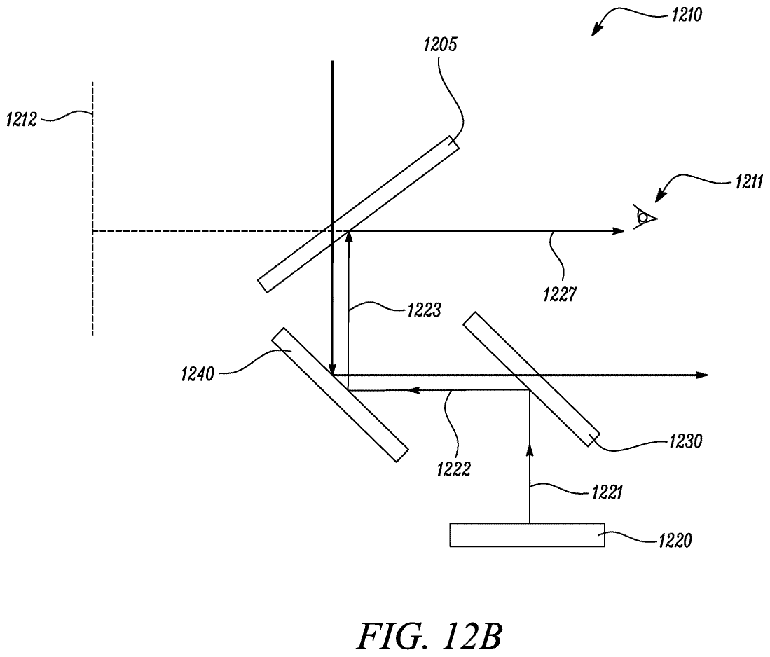

In some embodiments, the first polymeric layers 11 may include a high index optical (HIO) layer. In some embodiments, the first polymeric layers 11 include a polyethylene terephthalate (PET). The multilayer optical film 10, including materials such as PET, may not discolor due to exposure to sunlight, and specifically to ultraviolet (UV) light present in sunlight. This may allow the multilayer optical film 10 to be used in applications, such as in a windshield of a vehicle (e.g., a windshield 1205 of a vehicle 1200 shown in FIGS. 12A and 12B), where the multilayer optical film 10 may not discolor due to exposure to UV light present in sunlight.

In some embodiments, the second polymeric layers 12 may include a low index optical (LIO) layer. In some embodiments, the LIO layers may include glycol-modified polyethylene terephthalate (PETg). In some embodiments, the LIO layers may include CoPET (copolymer of polyethylene terephthalate), or a blend of polycarbonate and CoPET.

Each of the first and second polymeric layers 11, 12 has an average thickness t. The average thickness t is defined along the z-axis. The term “average thickness t” as used herein, refers to an average thickness along a plane (i.e., the x-y plane) of each of the first and second polymeric layers 11, 12. Each of the first and second polymeric layers 11, 12 has the average thickness t of less than about 500 nanometers (nm). In some embodiments, each of the first and second polymeric layers 11, 12 has the average thickness t of less than about 400 nm, less than about 300 nm, less than about 250 nm, or less than about 200 nm.

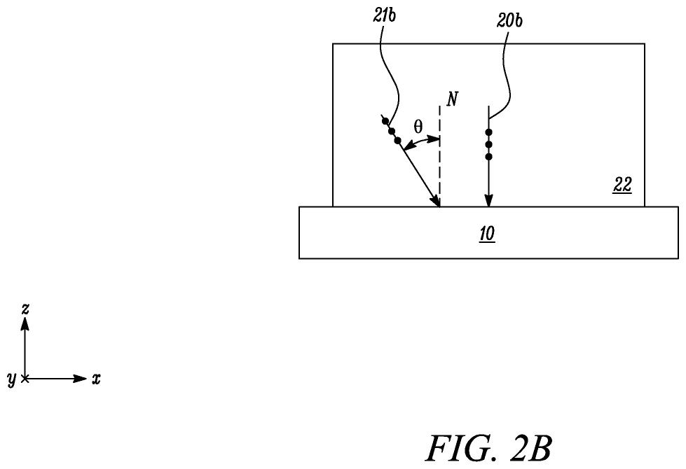

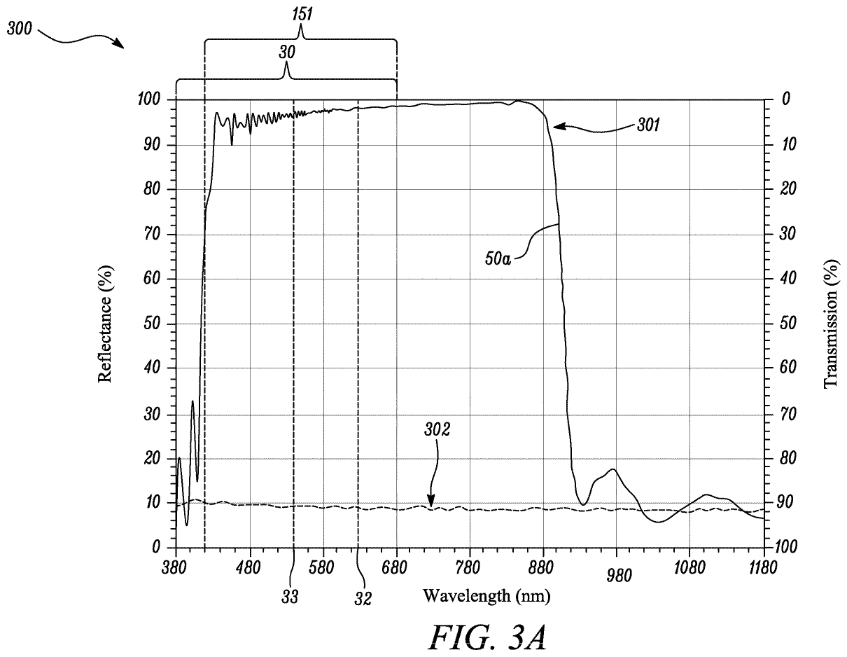

The first and second polymeric layers 11, 12 have respective indices of refraction nx1 and nx2 along the same in-plane first direction. In other words, the first and second polymeric layers 11, 12 have the respective indices of refraction nx1 and nx2 along the x-axis. In some embodiments, a difference between nx1 and nx2 is greater than or equal to about 0.1 and less than or equal to about 0.25 at at least one visible wavelength 32 (shown in FIG. 3A) in a visible wavelength range 151 (shown in FIG. 3A) extending from about 420 nm to about 680 nm. In other words, at the at least one visible wavelength 32 in the visible wavelength range 151, 0.1≤(nx1−nx2)≤0.25. Therefore, the first polymeric layers 11 have the index of refraction nx1 greater than the index of refraction nx2 of the second polymeric layers 12 along at least the same in-plane first direction. In some embodiments, 0.11≤(nx1−nx2)≤0.22, 0.12≤(nx1−nx2)≤0.2, or 0.12≤(nx1−nx2)≤0.19 at the at least one visible wavelength 32. In some examples, (nx1−nx2) is about 0.138, about 0.16, about 0.178, or about 0.179 at the at least one visible wavelength 32.

As discussed above, the first polymeric layers 11 have the index of refraction nx1 along the same in-plane first direction (i.e., the x-axis). In some embodiments, a magnitude of nx1 is greater than or equal to about 1.65 and less than or equal to about 1.75 at the at least one visible wavelength 32, i.e., 1.65≤nx1≤1.75. In some examples, nx1 is about 1.672, about 1.688, about 1.702, or about 1.711 at the at least one visible wavelength 32. In some examples, the at least one visible wavelength 32 is about 633 nm.

In some embodiments, the first and second polymeric layers 11, 12 have respective indices of refraction ny1 and ny2 along the same in-plane second direction orthogonal to the first direction. In other words, the first and second polymeric layers 11, 12 have the respective indices of refraction ny1 and ny2 along the y-axis. In some embodiments, a difference between ny1 and ny2 is greater than or equal to about 0.1 at the at least one visible wavelength 32, i.e., (ny1−ny2)≥0.1. Therefore, ny1 is greater than ny2 at the at least one visible wavelength 32. In some embodiments, (ny1−ny2)≥0.2, (ny1−ny2)≥0.3, (ny1−ny2)≥0.4, or (ny1−ny2)≥0.5 at the at least one visible wavelength 32. In some examples, (ny1−ny2) is about 0.153 at the at least one visible wavelength 32.

In some other embodiments, a magnitude of a difference between ny1 and ny2 is less than about 0.05 at the at least one visible wavelength 32, i.e., |ny1−ny2|<0.05. In some embodiments, ny1 and ny2 may be substantially equal to each other at the at least one visible wavelength 32. In some embodiments, |ny1−ny2|<0.04, |ny1−ny2|<0.03, |ny1−ny2|<0.02, |ny1−ny2|<0.01, or |ny1−ny2|<0.005 at the at least one visible wavelength 32. In some examples |ny1−ny2| is about 0, or about 0.017 at the at least one visible wavelength 32.

As discussed above, the first polymeric layers 11 have the index of refraction ny1 along the same in-plane second direction (i.e., the y-axis). In some embodiments, a magnitude of ny1 is greater than or equal to about 1.5 and less than or equal to about 1.75 at the at least one visible wavelength 32, i.e., 1.5≤ny1≤1.75. In some examples, ny1 is about 1.547, about 1.647, about 1.681, or about 1.7107 at the at least one visible wavelength 32.

In some embodiments, the first and second polymeric layers 11, 12 have respective indices of refraction nz1 and nz2 along the same out-of-plane direction orthogonal to the first direction. In other words, the first and second polymeric layers 11, 12 have the respective indices of refraction nz1 and nz2 along the z-axis. In some embodiments, a magnitude of difference between nz1 and nz2 is less than about 0.05 at the at least one visible wavelength 32, i.e., |nz1−nz2|<0.05. In some embodiments, nz1 and nz2 may be substantially equal to each other at the at least one visible wavelength 32. In some embodiments, |nz1−nz2|<0.04, |nz1−nz2|<0.03, |nz1−nz2|<0.02, |nz1−nz2|<0.01, or |nz1−nz2|<0.005 at the at least one visible wavelength 32. In some examples |nz1−nz2| is about 0, about 0.001, or about 0.021 at the at least one visible wavelength 32.

As discussed above, the first polymeric layers 11 have the index of refraction nz1 along the same out-of-plane direction (i.e., the z-axis) orthogonal to the first direction (i.e., the x-axis). In some embodiments, a magnitude of nz1 is greater than or equal to about 1.47 and less than or equal to 1.56 at the at least one visible wavelength 32, i.e., 1.47≤nz1≤1.56. In some examples, nz1 is about 1.493, about 1.500, about 1.510, or about 1.543 at the at least one visible wavelength 32.

In some embodiments, the multilayer optical film 10 may further include opposing first and second skin layers 13, 14. In some embodiments, the first and second polymeric layers 11, 12 may be disposed between the first and second skin layers 13, 14. In such cases, the first and second skin layers 13, 14 may include the first and second major surfaces 110, 111, respectively, and may form respective first and second interfaces with the external environment. In some embodiments, the first and second skin layers 13, 14 may act as protective layers for the multilayer optical film 10, such as protective boundary layers (PBL).

In some embodiments, the multilayer optical film 10 may further include an intermediate layer 15 disposed between adjacent first and second polymeric layers 11, 12. In some embodiments, the intermediate layer 15 may be disposed between two stacks of first and second polymeric layers 11, 12. In the illustrated embodiment of FIG. 1A, the intermediate layer 15 is disposed between first and second polymeric layers 11a, 12a. In some embodiments, a material composition of the intermediate layer 15 may be substantially similar to at least one of the first and second skin layers 13, 14.

In some embodiments, the plurality of first and second polymeric layers 11, 12, the first and second skin layers 13, 14, and the intermediate layer 15 may be disposed adjacent to each other along the z-axis of the multilayer optical film 10. In some embodiments, the plurality of first and second polymeric layers 11, 12, the first and second skin layers 13, 14, and the intermediate layer 15 may be substantially co-extensive with each other, or have substantially similar in-plane dimensions (i.e., length and width). In some embodiments, the plurality of first and second polymeric layers 11, 12, the first and second skin layers 13, 14, and the intermediate layer 15 may be substantially co-extensive with each other in the x-y plane.

The multilayer optical film 10 may have any suitable total thickness based on desired application attributes. In some embodiments, desired optical properties of the of multilayer optical film 10 may be achieved by varying various parameters, such as at least one of materials and average thicknesses of the first and second polymeric layers 11, 12, the first and second skin layers 13, 14, and the intermediate layer 15. Further, the desired properties may be achieved by varying the total number of the first and second polymeric layers 11, 12, and at least one of the refractive indices nx1, ny1, nz1, nx2, ny2, nz2 of the first and second polymeric layers 11, 12.

Specifically, the optical properties of the multilayer optical film 10 may be varied by varying at least one of: the total number of the first and second polymeric layers 11, 12; the at least one of the refractive indices nx1, ny1, nz1, nx2, ny2, nz2 of the first and second polymeric layers 11, 12; and the average thickness of at least one of the first and second polymeric layers 11, 12.

An example of the multilayer optical film 10 (Sample A) may include the first and second polymeric layers 11, 12 numbering 650 in total and having refractive indices at the at least one visible wavelength 32 as shown in Table 1 below.

TABLE 1
Refractive Indices of Sample A

| nx1 | ny1 | nz1 | nx2 | ny2 | nz2 | Δnx | Δny | Δnz |
|---|---|---|---|---|---|---|---|---|
| 1.702 | 1.547 | 1.543 | 1.542 | 1.547 | 1.543 | 0.16 | 0 | 0 |

Another example of the multilayer optical film 10 (Sample B) may include the first and second polymeric layers 11, 12 numbering 650 in total and having refractive indices at the at least one visible wavelength 32 as shown in Table 2 below.

TABLE 2
Refractive Indices of Sample B

| nx1 | ny1 | nz1 | nx2 | ny2 | nz2 | Δnx | Δny | Δnz |
|---|---|---|---|---|---|---|---|---|
| 1.702 | 1.547 | 1.543 | 1.564 | 1.564 | 1.564 | 0.138 | 0.017 | 0.021 |

Another example of the multilayer optical film 10 (Sample C) may include the first and second polymeric layers 11, 12 numbering 650 in total and having refractive indices at the at least one visible wavelength 32 as shown in Table 3 below.

TABLE 3
Refractive Indices of Sample C

| nx1 | ny1 | nz1 | nx2 | ny2 | nz2 | Δnx | Δny | Δnz |
|---|---|---|---|---|---|---|---|---|
| 1.702 | 1.547 | 1.543 | 1.542 | 1.547 | 1.543 | 0.16 | 0 | 0 |

Another example of the multilayer optical film 10 (Sample D) may include the first and second polymeric layers 11, 12 having refractive indices at the at least one visible wavelength 32 as shown in Table 4 below.

TABLE 4
Refractive Indices of Sample D

| nx1 | ny1 | nz1 | nx2 | ny2 | nz2 | Δnx | Δny | Δnz |
|---|---|---|---|---|---|---|---|---|
| 1.672 | 1.647 | 1.493 | 1.494 | 1.494 | 1.494 | 0.178 | 0.153 | 0.001 |

Another example of the multilayer optical film 10 (Sample E) may include the first and second polymeric layers 11, 12 numbering 276 in total and having refractive indices at the at least one visible wavelength 32 as shown in Table 5 below.

TABLE 5
Refractive Indices of Sample E

| nx1 | ny1 | nz1 | nx2 | ny2 | nz2 | Δnx | Δny | Δnz |
|---|---|---|---|---|---|---|---|---|
| 1.672 | 1.647 | 1.493 | 1.494 | 1.494 | 1.494 | 0.178 | 0.153 | 0.001 |

Another example of the multilayer optical film 10 (Sample F) may include the first and second polymeric layers 11, 12 numbering 276 in total and having refractive indices at the at least one visible wavelength 32 as shown in Table 6 below.

TABLE 6
Refractive Indices of Sample F

| nx1 | ny1 | nz1 | nx2 | ny2 | nz2 | Δnx | Δny | Δnz |
|---|---|---|---|---|---|---|---|---|
| 1.659 | 1.659 | 1.493 | 1.494 | 1.494 | 1.494 | 0.178 | 0.153 | 0.001 |

In some embodiments, the Samples A, B and C may be reflective polarizers and Samples D, E, and F may be mirrors or partial mirrors.

In some embodiments, by varying the number and the thickness of the first and second polymeric layers 11, 12, and the respective refractive indices x1, y1, z1, x2, y2, z2 of the first and second polymeric layers 11, 12, the multilayer optical film 10 may be configured as a reflective polarizer or as a mirror.

FIG. 1B illustrates a plot 200 of thickness profiles of the plurality of alternating first and second polymeric layers 11, 12 of the multilayer optical film 10 (shown in FIG. 1A) having different configurations, according to an embodiment of the present disclosure. Specifically, the plot 200 depicts a variation in thickness of the plurality of alternating first and second polymeric layers 11, 12 of the multilayer optical film 10. The thickness of the first and second polymeric layers 11, 12 is depicted in nanometers (nm) on the ordinate axis, and the layer number is depicted on the abscissa.

The plot 200 includes a thickness curve 201 and a thickness curve 202 depicting the variation in thickness of the first and second polymeric layers 11, 12 of the multilayer optical film 10 having different configurations. Specifically, the thickness curve 201 depicts the variation in thickness of the first and second polymeric layers 11, 12 of the Sample A (described with reference to FIG. 1A and Table 1) of the multilayer optical film 10, and the thickness curve 202 depicts the variation in thickness of the first and second polymeric layers 11, 12 of the Sample B (described with reference to FIG. 1A and Table 2) of the multilayer optical film 10.

As is apparent from the thickness curves 201, 202, the multilayer optical film 10 has a substantially linear thickness profile along a majority of its thickness. Specifically, each of the Samples A, B has a substantially linear thickness profile along a majority of its thickness. In some embodiments, the multilayer optical film 10 may have a substantially linear thickness profile along at least about 60% of its thickness. In some embodiments, the multilayer optical film 10 may have a substantially linear thickness profile along at least about 70%, about 80%, or about 90% of its thickness.

Referring again to FIG. 1A, incident lights 20, 21 incident on the multilayer optical film 10, and propagating in an incident plane 22 are illustrated. The incident plane 22 includes the first direction. In other words, the incident plane 22 includes the x-axis. The incident plane 22 further includes a normal N to the multilayer optical film 10. The normal N is substantially orthogonal to the plane of the multilayer optical film 10 (i.e., the x-y plane). Therefore, the incident plane 22 substantially corresponds to the x-z plane of the multilayer optical film 10.

In some embodiments, the incident lights 20, 21 are incident at at least one of the first and second interfaces of the multilayer optical film 10, i.e., the incident lights 20, 21 are incident at the at least one of the first and second major surfaces 110, 111 of the multilayer optical film 10. In the illustrated embodiment of FIG. 1, the incident lights 20, 21 are incident at the first major surface 110 of the multilayer optical film 10. The incident light 20 is a substantially normally incident light. The incident light 21 is incident on the multilayer optical film 10 at an incident angle θ with respect to the normal N.

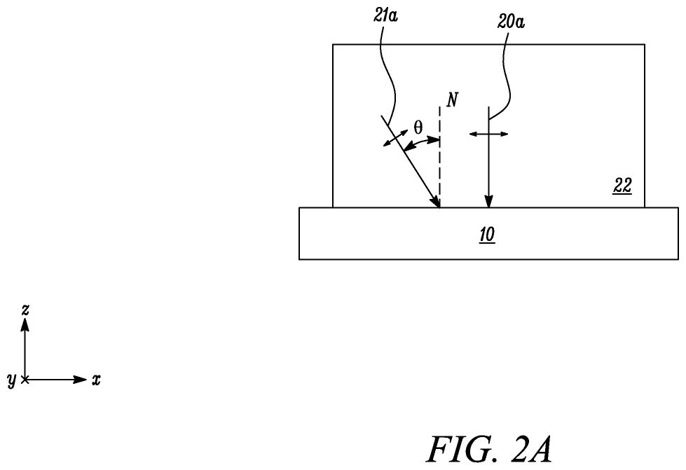

FIGS. 2A and 2B illustrate schematic sectional views of the multilayer optical film 10, according to an embodiment of the present disclosure. Specifically, FIG. 2A illustrates incident lights 20a, 21a propagating in the incident plane 22 and FIG. 2B illustrates incident lights 20b and 21b propagating in the incident plane 22.

The incident lights 20a, 20b are incident substantially normally on the multilayer optical film 10, i.e., the incident lights 20a, 20b make an angle of about 0 degree with respect to the normal N of the multilayer optical film 10. The incident lights 21a, 21b are incident on the multilayer optical film 10 at the incident angle θ with respect to the normal N to the multilayer optical film 10. In some embodiments, the incident angle θ is at least 40 degrees. In some embodiments, the incident angle θ is at least 45 degrees, at least 50 degrees, at least 55 degrees, or at least 60 degrees. In some examples, the incident angle θ is about 60 degrees.

In some embodiments, the incident lights 20a, 21a may be p-polarized incident light. The incident light 20a and the incident light 21a may be interchangeably referred to as “the p-polarized incident light 20a” and “the p-polarized incident light 21a”, respectively. Specifically, the incident light 20a may be polarized along the first direction (i.e., the x-axis). Therefore, the incident light 20a may be interchangeably referred to as “the substantially normally incident light 20a polarized along the first direction”.

In some embodiments, the incident lights 20b, 21b may be s-polarized incident light. The incident light 20b and the incident light 21b may be interchangeably referred to as “the s-polarized incident light 20b” and “the s-polarized incident light 21b”, respectively. In some embodiments, the incident lights 20b, 21b may be polarized along the second direction (i.e., the y-axis). Therefore, the incident light 20b and the incident light 21b may be interchangeably referred to as “the substantially normally incident light 20b polarized along the second direction” and “the incident light 21b polarized along the second direction”, respectively.

FIG. 3A illustrates a plot 300 depicting optical characteristics of the multilayer optical film 10 for the substantially normally incident lights 20a, 20b (shown in FIGS. 2A and 2B), according to an embodiment of the present disclosure. Specifically, the plot 300 depicts optical reflectance of the plurality of alternating first and second polymeric layers 11, 12 of the Sample A (described with reference to FIG. 1A and Table 1) of the multilayer optical film 10. Wavelength is expressed in nanometers (nm) in the abscissa. Optical reflectance is expressed as a reflectance percentage in the left ordinate axis. Optical transmission is expressed as a transmission percentage on the right ordinate axis. Transmission percentage is approximated to be complementary to the reflectance percentage, i.e., transmission percentage=(100−reflectance percentage).

Referring to FIGS. 1A, 2A-2B and 3A, the plot 300 includes a curve 301 corresponding to an optical reflectance of the Sample A for the substantially normally incident light 20a polarized along the first direction. The curve 301 may interchangeably be referred to as “the optical reflectance of the plurality of alternating first and second polymeric layers versus wavelength 301”, or “the optical reflectance versus wavelength 301” of the Sample A. The optical reflectance versus wavelength 301 illustrates a variation of the optical reflectance of the plurality of alternating first and second polymeric layers 11, 12 of the Sample A with wavelength for the substantially normally incident light 20a polarized along the first direction.

As can be observed from the curve 301, for the substantially normally incident light 20a polarized along the first direction, the plurality of alternating first and second polymeric layers 11, 12 of the Sample A reflects greater than about 80% of the incident light 20a for at least a first wavelength 33 in a first wavelength range 30 extending from about 380 nm to about 680 nm. In some examples, for the substantially normally incident p-polarized incident light 20a, the plurality of alternating first and second polymeric layers 11, 12 of the Sample A reflects greater than about 80% of the incident light 20a for the at least the first wavelength 33 in the first wavelength range 30. In some embodiments, for the substantially normally incident light 20a polarized along the first direction, the plurality of alternating first and second polymeric layers 11, 12 of the Sample A reflects greater than about 85%, greater than about 90%, greater than about 95%, or greater than about 98% of the incident light 20a for the at least the first wavelength 33 in the first wavelength range 30. Therefore, for the substantially normally incident light 20a polarized along the first direction, the Sample A substantially reflects the incident light 20a for the at least the first wavelength 33 in the first wavelength range 30.

In the illustrated embodiment of FIG. 3A, for the substantially normally incident light 20a polarized along the first direction, the Sample A reflects about 96% of the incident light 20a for the first wavelength 33 of about 540 nm.

Further, as can be observed from the plot 300, for the substantially normally incident light 20a polarized along the first direction, the optical reflectance versus wavelength 301 includes a reflection band edge 50a along which the optical reflectance of the Sample A generally decreases with increasing wavelength.

The plot 300 further includes a curve 302 corresponding to an optical transmittance of the Sample A for the substantially normally incident light 20b polarized along the second direction. As can be observed from the curve 302, for the substantially normally incident light 20b polarized along the second direction, the plurality of alternating first and second polymeric layers 11, 12 of the Sample A transmits greater than about 60% of the incident light 20b for the at least the first wavelength 33 in the first wavelength range 30. In other words, for the substantially normally incident light 20b polarized along the y-axis, the plurality of alternating first and second polymeric layers 11, 12 of the Sample A transmits greater than about 60% of the incident light 20b for the at least the first wavelength 33 in the first wavelength range 30. In some examples, for the substantially normally incident s-polarized incident light 20b, the plurality of alternating first and second polymeric layers 11, 12 of the Sample A transmits greater than about 60% of the incident light 20b for the at least the first wavelength 33 in the first wavelength range 30. In some embodiments, for the substantially normally incident light 20b polarized along the second direction, the plurality of alternating first and second polymeric layers 11, 12 of the Sample A transmits greater than about 70%, greater than about 75%, greater than about 80%, greater than about 85%, or greater than 90% of the incident light 20b for the at least the first wavelength 33 in the first wavelength range 30. Therefore, for the substantially normally incident light 20b polarized along the second direction, the Sample A substantially transmits the incident light 20b for the at least the first wavelength 33 in the first wavelength range 30.

In the illustrated embodiment of FIG. 3A, for the substantially normally incident light 20b polarized along the second direction, the Sample A transmits about 90% of the incident light 20b for the first wavelength 33 of about 540 nm.

Since the Sample A substantially reflects the incident light 20a polarized along the first direction and substantially transmits the incident light 20b polarized along the second direction for the first wavelength 33 of about 540 nm, the Sample A may be a reflective polarizer.

FIG. 3B illustrates a plot 313 depicting a best linear fit 50d to the reflection band edge 50a of the optical reflectance versus wavelength 301 (shown in FIG. 3A), according to an embodiment of the present disclosure. Specifically, the best linear fit 50d to the reflection band edge 50a is at least across a wavelength range along the reflection band edge 50a where the optical reflectance decreases from about 70% to about 30%.

The best linear fit 50d to the reflection band edge 50a has a negative slope 52a and an r-squared value R1. In some embodiments, the best linear fit 50d to the reflection band edge 50a at least across the wavelength range along the reflection band edge 50a where the optical reflectance decreases from about 70% to about 30% has the negative slope 52a having a magnitude of greater than about 1%/nm. In some embodiments, the best linear fit 50d to the reflection band edge 50a at least across the wavelength range along the reflection band edge 50a where the optical reflectance decreases from about 70% to about 30% has the negative slope 52a having a magnitude of greater than about 1.5%/nm, greater than about 2%/nm, greater than about 2.5%/nm, greater than about 3%/nm, greater than about 3.5%/nm, greater than about 4%/nm, greater than about 4.5%/nm, greater than about 5%/nm, or greater than about 5.5%/nm.

The best linear fit 50d can be determined as a linear least squares fit to the optical reflectance versus wavelength 301 at least across the wavelength range along the reflection band edge 50a where the optical reflectance decreases from about 70% to about 30%. The r-squared value may also be known as co-efficient of determination. The r-squared value is a statistical measure of goodness of fit of a linear fit with a respective plot and can range from a value of 0 indicating a negligible fit, to a value of 1 indicating a perfect fit. Generally, a r-squared value of greater than about 0.95 may be considered as a good fit.

In the illustrated embodiment of FIG. 3B, the best linear fit 50d is according to Equation 1 provided below,

$$y = - 0.0319 x + 29.519 \qquad ( Equation 1 )$$

In Equation 1, “y” denotes the optical reflectance of the Sample A for the substantially normally incident light 20a polarized along the first direction, and “x” denotes the wavelength. Further, the magnitude of the slope 52a=0.0319 or 3.19%/nm, and R1=0.9992.

Since the reflection band edge 50a is a sharp band edge, the reflection band edge 50a may substantially separate a wavelength range extending from about 400 nm to about 900 nm from another wavelength range extending from about 920 nm to about 1180 nm. The slope 52a of the best linear fit 50d of about 3.19%/nm may provide a sharp cut-off between wavelength ranges that the reflection band edge 50a separates. The sharp cut-off, in turn, may reduce leakages of the incident light 20a between the two wavelength ranges. In other words, the Sample A may provide a high contrast.

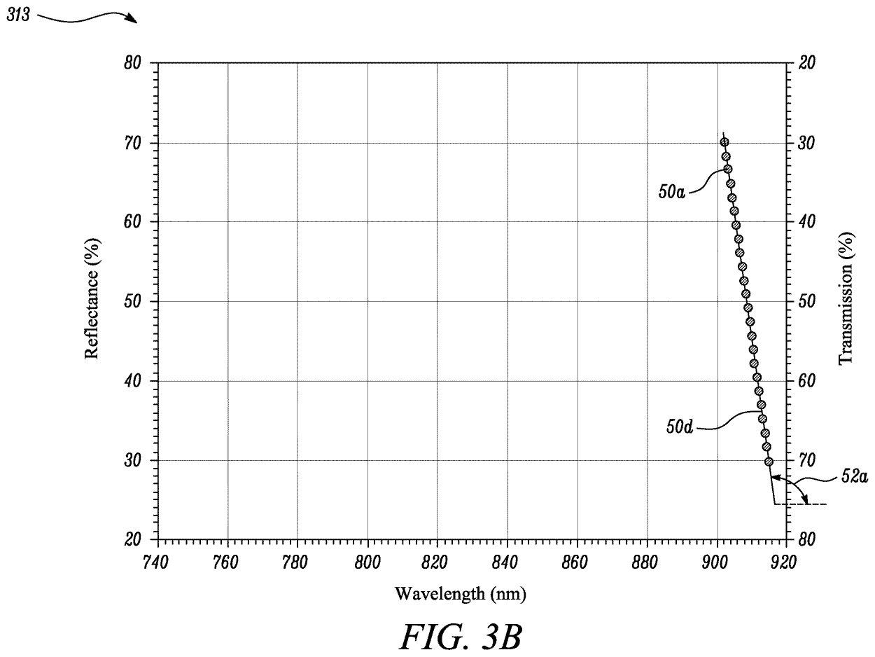

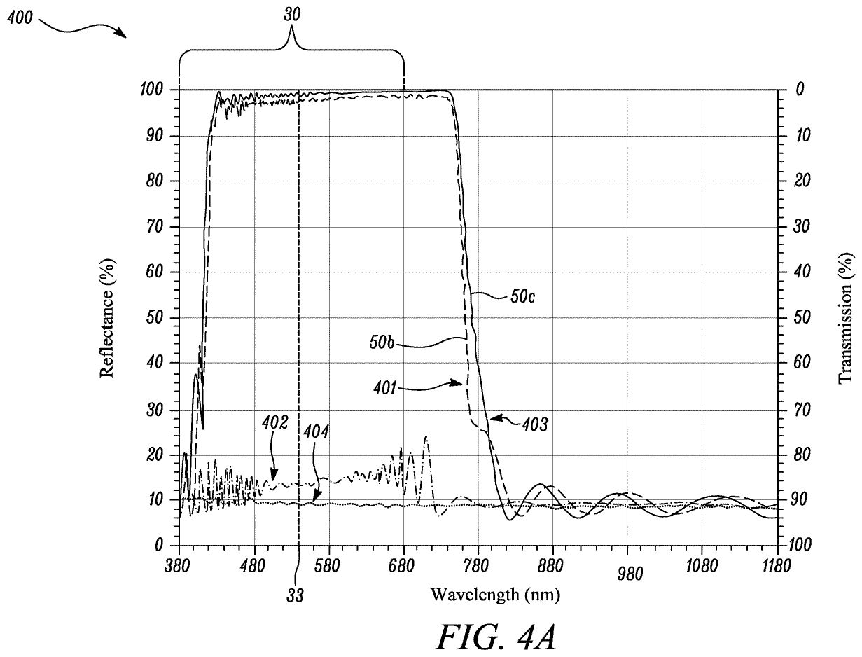

FIG. 4A illustrates another plot 400 depicting optical characteristics of the multilayer optical film 10 for the substantially normally incident lights 20a, 20b (shown in FIGS. 2A, 2B), according to an embodiment of the present disclosure. Specifically, the plot 400 depicts optical reflectances of the plurality of alternating first and second polymeric layers 11, 12 of the Samples B and C (described with reference to FIG. 1A and the respective Tables 2, 3) of the multilayer optical film 10. Wavelength is expressed in nanometers (nm) in the abscissa. Optical reflectance is expressed as a reflectance percentage in the left ordinate axis. Optical transmission is expressed as a transmission percentage on the right ordinate axis. Transmission percentage is approximated to be complementary to the reflectance percentage, i.e., transmission percentage=(100−reflectance percentage).

Referring to FIGS. 1A, 2A-2B and 4A, the plot 400 includes a curve 401 corresponding to an optical reflectance of the Sample B for the substantially normally incident light 20a polarized along the first direction. The curve 401 may interchangeably be referred to as “the optical reflectance of the plurality of alternating first and second polymeric layers versus wavelength 401”, or “the optical reflectance versus wavelength 401” of the Sample B. The optical reflectance versus wavelength 401 illustrates a variation of the optical reflectance of the plurality of alternating first and second polymeric layers 11, 12 of the Sample B with wavelength for the substantially normally incident light 20a polarized along the first direction.

As can be observed from the curve 401, for the substantially normally incident light 20a polarized along the first direction, the plurality of alternating first and second polymeric layers 11, 12 of the Sample B reflects greater than about 80% of the incident light 20a for the at least the first wavelength 33 in the first wavelength range 30. In some examples, for the substantially normally incident p-polarized incident light 20a, the plurality of alternating first and second polymeric layers 11, 12 of the Sample B reflects greater than about 80% of the incident light 20a for the at least the first wavelength 33 in the first wavelength range 30. Therefore, for the substantially normally incident light 20a polarized along the first direction, the Sample B substantially reflects the incident light 20a for the at least the first wavelength 33 in the first wavelength range 30.

In the illustrated embodiment of FIG. 4A, for the substantially normally incident light 20a polarized along the first direction, the Sample B reflects about 97% of the incident light 20a for the first wavelength 33 of about 540 nm.

Further, as can be observed from the plot 400, for the substantially normally incident light 20a polarized along the first direction, the optical reflectance versus wavelength 401 includes a reflection band edge 50b along which the optical reflectance of the Sample B generally decreases with increasing wavelength.

The plot 400 further includes a curve 402 corresponding to an optical transmittance of the Sample B for the substantially normally incident light 20b polarized along the second direction. As can be observed from the curve 402, for the substantially normally incident light 20b polarized along the second direction, the plurality of alternating first and second polymeric layers 11, 12 of the Sample B transmits greater than about 60% of the incident light 20b for the at least the first wavelength 33 in the first wavelength range 30. In some examples, for the substantially normally incident s-polarized incident light 20b, the plurality of alternating first and second polymeric layers 11, 12 of the Sample B transmits greater than about 60% of the incident light 20b for the at least the first wavelength 33 in the first wavelength range 30. Therefore, for the substantially normally incident light 20b polarized along the second direction, the Sample B substantially transmits the incident light 20b for the at least the first wavelength 33 in the first wavelength range 30.

In the illustrated embodiment of FIG. 4A, for the substantially normally incident light 20b polarized along the second direction, the Sample B transmits about 84% of the incident light 20b for the first wavelength 33 of about 540 nm.

Since the Sample B substantially reflects the incident light 20a polarized along the first direction and substantially transmits the incident light 20b polarized along the second direction for the first wavelength 33 of about 540 nm, the Sample B may be a reflective polarizer.

The plot 400 further includes a curve 403 corresponding to an optical reflectance of the Sample C for the substantially normally incident light 20a polarized along the first direction. The curve 403 may interchangeably be referred to as “the optical reflectance of the plurality of alternating first and second polymeric layers versus wavelength 403”, or “the optical reflectance versus wavelength 403” of the Sample C. The optical reflectance versus wavelength 403 illustrates a variation of the optical reflectance of the plurality of alternating first and second polymeric layers 11, 12 of the Sample C with wavelength for the substantially normally incident light 20a polarized along the first direction.

As can be observed from the curve 403, for the substantially normally incident light 20a polarized along the first direction, the plurality of alternating first and second polymeric layers 11, 12 of the Sample C reflects greater than about 80% of the incident light 20a for the at least the first wavelength 33 in the first wavelength range 30. In some examples, for the substantially normally incident p-polarized incident light 20a, the plurality of alternating first and second polymeric layers 11, 12 of the Sample C reflects greater than about 80% of the incident light 20a for the at least the first wavelength 33 in the first wavelength range 30. Therefore, for the substantially normally incident light 20a polarized along the first direction, the Sample C substantially reflects the incident light 20a for the at least the first wavelength 33 in the first wavelength range 30.

In the illustrated embodiment of FIG. 4A, for the substantially normally incident light 20a polarized along the first direction, the Sample C reflects about 98% of the incident light 20a for the first wavelength 33 of about 540 nm.

Further, as can be observed from the plot 400, for the substantially normally incident light 20 polarized along the first direction, the optical reflectance versus wavelength 403 includes a reflection band edge 50c along which the optical reflectance of the Sample C generally decreases with increasing wavelength.

The plot 400 further includes a curve 404 corresponding to an optical transmittance of the Sample C for the substantially normally incident light 20b polarized along the second direction. As can be observed from the curve 404, for the substantially normally incident light 20b polarized along the second direction, the plurality of alternating first and second polymeric layers 11, 12 of the Sample C transmits greater than about 60% of the incident light 20b for the at least the first wavelength 33 in the first wavelength range 30. In some examples, for the substantially normally incident s-polarized incident light 20b, the plurality of alternating first and second polymeric layers 11, 12 of the Sample C transmits greater than about 60% of the incident light 20b for the at least the first wavelength 33 in the first wavelength range 30. Therefore, for the substantially normally incident light 20b polarized along the second direction, the Sample C substantially transmits the incident light 20b for the at least the first wavelength 33 in the first wavelength range 30.

In the illustrated embodiment of FIG. 4A, for the substantially normally incident light 20b polarized along the second direction, the Sample C transmits about 90% of the incident light 20b for the first wavelength 33 of about 540 nm.

Since the Sample C substantially reflects the incident light 20a polarized along the first direction and substantially transmits the incident light 20b polarized along the second direction for the first wavelength 33 of about 540 nm, the Sample C may be a reflective polarizer.

FIG. 4B illustrates a plot 413 depicting best linear fits 50e, 50f corresponding to the reflection band edges 50b, 50c of the respective optical reflectances versus wavelength 401, 403 (shown in FIG. 4A), according to an embodiment of the present disclosure. Specifically, the best linear fit 50e to the reflection band edge 50b is at least across a wavelength range along the reflection band edge 50b where the optical reflectance decreases from about 70% to about 30%. The best linear fit 50f to the reflection band edge 50c is at least across a wavelength range along the reflection band edge 50c where the optical reflectance decreases from about 70% to about 30%.

The best linear fit 50e to the reflection band edge 50b has a negative slope 52b and an r-squared value R2. In some embodiments, the best linear fit 50e to the reflection band edge 50b at least across the wavelength range along the reflection band edge 50b where the optical reflectance decreases from about 70% to about 30% has the negative slope 52b having a magnitude of greater than about 1%/nm. In the illustrated embodiment of FIG. 4B, the best linear fit 50e is according to Equation 2 provided below,

$$y = - 0.0382 x + 29.686 \qquad ( Equation 2 )$$

In Equation 2, “y” denotes the optical reflectance of the Sample B for the substantially normally incident light 20a polarized along the first direction, and “x” denotes the wavelength. Further, the magnitude of the slope 52b=0.0382 or 3.82%/nm, and R2=0.9866.

Since the reflection band edge 50b is a sharp band edge, the reflection band edge 50b may substantially separate a wavelength range extending from about 380 nm to about 750 nm from another wavelength range extending from about 770 nm to about 1180 nm. The slope 52b of the best linear fit 50e of about 3.82%/nm may provide a sharp cut-off between wavelength ranges that the reflection band edge 50b separates. The sharp cut-off, in turn, may reduce leakages of the incident light 20a between the two wavelength ranges. In other words, the Sample B may provide a high contrast.

The best linear fit 50f to the reflection band edge 50c has a negative slope 52c and an r-squared value R3. In some embodiments, the best linear fit 50f to the reflection band edge 50c at least across the wavelength range along the reflection band edge 50c where the optical reflectance decreases from about 70% to about 30% has the negative slope 52c having a magnitude of greater than about 1%/nm. In the illustrated embodiment of FIG. 4B, the best linear fit 50f is according to Equation 3 provided below,

$$y = - 0.0135 x + 10.917 \qquad ( Equation 3 )$$

In Equation 3, “y” denotes the optical reflectance of the Sample C for the substantially normally incident light 20a polarized along the first direction, and “x” denotes the wavelength. Further, the magnitude of the slope 52c=0.0135 or 1.35%/nm, and R3=0.9817.

Since the reflection band edge 50c is a sharp band edge, the reflection band edge 50c may substantially separate a wavelength range extending from about 380 nm to about 760 nm from another wavelength range extending from about 790 nm to about 1180 nm. The slope 52c of the best linear fit 50f of about 1.35%/nm may provide a sharp cut-off between wavelength ranges that the reflection band edge 50c separates. The sharp cut-off, in turn, may reduce leakages of the incident light 20a between the two wavelength ranges. In other words, the Sample C may provide a high contrast.

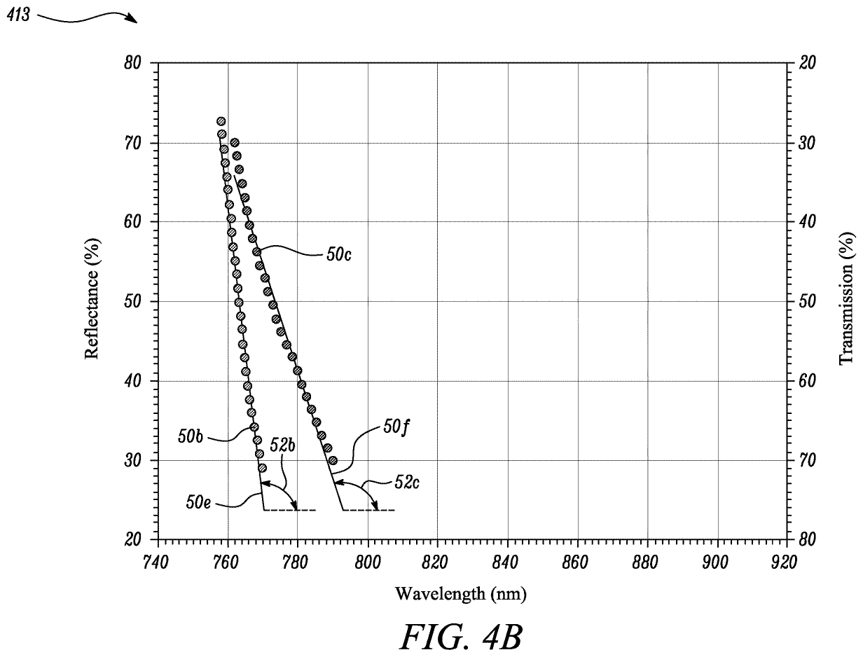

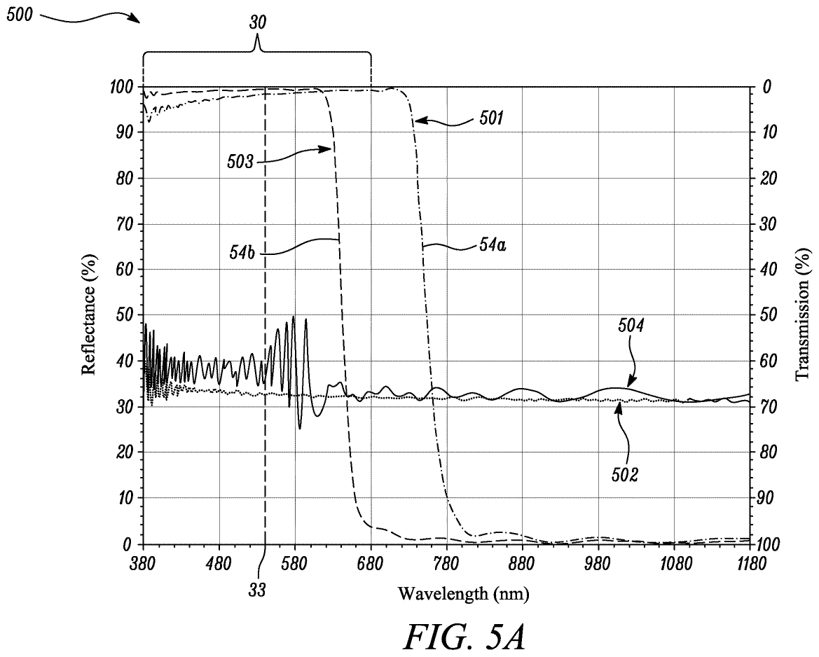

FIG. 5A illustrates another plot 500 depicting optical characteristics of the multilayer optical film 10 for the incident lights 21a, 21b (shown in FIGS. 2A and 2B) incident at the incident angle θ, according to an embodiment of the present disclosure. Specifically, the plot 500 depicts optical reflectances of the plurality of alternating first and second polymeric layers 11, 12 of the Samples A and B (described with reference to FIG. 1A and the respective Tables 1 and 2) of the multilayer optical film 10. Wavelength is expressed in nanometers (nm) in the abscissa. Optical reflectance is expressed as a reflectance percentage in the left ordinate axis. Optical transmission is expressed as a transmission percentage on the right ordinate axis. Transmission percentage is approximated to be complementary to the reflectance percentage, i.e., transmission percentage=(100−reflectance percentage).

Referring to FIGS. 1A, 2A-2B and 5A, the plot 500 includes a curve 501 corresponding to an optical reflectance of the Sample A for the p-polarized incident light 21a at the incident angle θ of at least 40 degrees in the incident plane 22 that includes the first direction. The curve 501 may interchangeably be referred to as “the optical reflectance of the plurality of alternating first and second polymeric layers versus wavelength 501”, or “the optical reflectance versus wavelength 501” of the Sample A. The optical reflectance versus wavelength 501 illustrates a variation of the optical reflectance of the plurality of alternating first and second polymeric layers 11, 12 of the Sample A with wavelength for the p-polarized incident light 21a incident at the incident angle θ of at least 40 degrees in the incident plane 22 that includes the first direction.

As can be observed from the curve 501, in some embodiments, for the p-polarized incident light 21a at the incident angle θ of at least 40 degrees in the incident plane 22 that includes the first direction, the plurality of alternating first and second polymeric layers 11, 12 of the Sample A reflects greater than about 80% of the incident light 21a for the at least the first wavelength 33 in the first wavelength range 30. Therefore, for the p-polarized incident light 21a at the incident angle θ of at least 40 degrees in the incident plane 22 that includes the first direction, the Sample A substantially reflects the incident light 21a for the at least the first wavelength 33 in the first wavelength range 30.

In the illustrated embodiment of FIG. 5A, for the p-polarized incident light 21a at the incident angle θ of about 60 degrees in the incident plane 22 that includes the first direction, the Sample A reflects about 98% of the incident light 21a for the first wavelength 33 of about 540 nm.

Further, as can be observed from the plot 500, for the p-polarized incident light 21a at the incident angle θ of at least 40 degrees in the incident plane 22 that includes the first direction, the optical reflectance versus wavelength 501 includes a reflection band edge 54a along which the optical reflectance of the Sample A generally decreases with increasing wavelength.

The plot 500 further includes a curve 502 corresponding to an optical transmittance of the Sample A for the s-polarized incident light 21b. As can be observed from the curve 502, in some embodiments, for the s-polarized incident light 21b, the plurality of alternating first and second polymeric layers 11, 12 of the Sample A transmits greater than about 50% of the incident light 21b for the at least the first wavelength 33 in the first wavelength range 30. Therefore, for the s-polarized incident light 21b incident at the incident angle θ of at least 40 degrees, the Sample A substantially transmits the incident light 21b for the at least the first wavelength 33 in the first wavelength range 30.

In the illustrated embodiment of FIG. 5A, for the s-polarized incident light 21b incident at the incident angle θ of at least 40 degrees, the Sample A transmits about 68% of the incident light 21b for the first wavelength 33 of about 540 nm.

The plot 500 further includes a curve 503 corresponding to an optical reflectance of the Sample B for the p-polarized incident light 21a at the incident angle θ of at least 40 degrees in the incident plane 22 that includes the first direction. The curve 503 may interchangeably be referred to as “the optical reflectance of the plurality of alternating first and second polymeric layers versus wavelength 503”, or “the optical reflectance versus wavelength 503” of the Sample B. The optical reflectance versus wavelength 503 illustrates a variation of the optical reflectance of the plurality of alternating first and second polymeric layers 11, 12 of the Sample B with wavelength for the p-polarized incident light 21a at the incident angle θ of at least 40 degrees in the incident plane 22 that includes the first direction.

As can be observed from the curve 503, in some embodiments, for the p-polarized incident light 21a at the incident angle θ of at least 40 degrees in the incident plane 22 that includes the first direction, the plurality of alternating first and second polymeric layers 11, 12 of the Sample B reflects greater than about 80% of the incident light 21a for the at least the first wavelength 33 in the first wavelength range 30. Therefore, for the p-polarized incident light 21a at the incident angle θ of at least 40 degrees in the incident plane 22 that includes the first direction, the Sample B substantially reflects the incident light 21a for the at least the first wavelength 33 in the first wavelength range 30.

In the illustrated embodiment of FIG. 5A, for the p-polarized incident light 21a at the incident angle θ of at least 40 degrees in the incident plane 22 that includes the first direction, the Sample B reflects about 98% of the incident light 21a for the first wavelength 33 of about 540 nm.

Further, as can be observed from the plot 500, for the p-polarized incident light 21a at the incident angle θ of at least 40 degrees in the incident plane 22 that includes the first direction, the optical reflectance versus wavelength 503 includes a reflection band edge 54b along which the optical reflectance of the Sample B generally decreases with increasing wavelength.

The plot 500 further includes a curve 504 corresponding to an optical transmittance of the Sample B for the s-polarized incident light 21b. As can be observed from the curve 504, in some embodiments, for the s-polarized incident light 21b, the plurality of alternating first and second polymeric layers 11, 12 of the Sample B transmits greater than about 50% of the incident light 21b for the at least the first wavelength 33 in the first wavelength range 30. Therefore, for the s-polarized incident light 21b incident at the incident angle θ of at least 40 degrees, the Sample B substantially transmits the incident light 21b for the at least the first wavelength 33 in the first wavelength range 30.

In the illustrated embodiment of FIG. 5A, for the s-polarized incident light 21b incident at the incident angle θ of at least 40 degrees, the Sample B transmits about 57% of the incident light 21b for the first wavelength 33 of about 540 nm.

FIG. 5B illustrates a plot 513 depicting best linear fits 56a, 56b corresponding to the reflection band edges 54a, 54b of the respective optical reflectances versus wavelength 501, 503 (shown in FIG. 5A), according to an embodiment of the present disclosure. Specifically, the best linear fit 56a to the reflection band edge 54a is at least across a wavelength range along the reflection band edge 54a where the optical reflectance decreases from about 70% to about 30%. The best linear fit 56b to the reflection band edge 54b is at least across a wavelength range along the reflection band edge 54b where the optical reflectance decreases from about 70% to about 30%.

The best linear fit 56a to the reflection band edge 54a has a negative slope 58a and an r-squared value R4. In some embodiments, the best linear fit 56a to the reflection band edge 54a at least across the wavelength range along the reflection band edge 54a where the optical reflectance decreases from about 70% to about 30% has the negative slope 58a having a magnitude of greater than about 2%/nm. In some embodiments, the best linear fit 56a to the reflection band edge 54a at least across the wavelength range along the reflection band edge 54a where the optical reflectance decreases from about 70% to about 30% has the negative slope 58a having a magnitude of greater than about 2.25%/nm, greater than about 2.5%/nm, greater than about 2.75%/nm, greater than about 3%/nm, greater than about 3.25%/nm, or greater than about 3.5%/nm. In the illustrated embodiment of FIG. 5B, the best linear fit 56a is according to Equation 4 provided below,

$$y = - 0.0257 x + 19.891 \qquad ( Equation 4 )$$

In Equation 4, “y” denotes the optical reflectance of the Sample A for the p-polarized incident light 21a at the incident angle θ of at least 40 degrees in the incident plane 22 that includes the first direction, and “x” denotes the wavelength. Further, the magnitude of the slope 58a=0.0257 or 2.57%/nm, and R4=0.9954.

Since the reflection band edge 54a is a sharp band edge, the reflection band edge 54a may substantially separate a wavelength range extending from about 380 nm to about 744 nm from another wavelength range extending from about 764 nm to about 1180 nm. The slope 58a of the best linear fit 56a of about 2.57%/nm may provide a sharp cut-off between wavelength ranges that the reflection band edge 54a separates. The sharp cut-off, in turn, may reduce leakages of the incident light 21a between the two wavelength ranges. In other words, the Sample A may provide a high contrast.

The best linear fit 56b to the reflection band edge 54b has a negative slope 58b and an r-squared value R5. In some embodiments, the best linear fit 56b to the reflection band edge 54b at least across the wavelength range along the reflection band edge 54b where the optical reflectance decreases from about 70% to about 30% has the negative slope 58b having a magnitude of greater than about 2%/nm. In the illustrated embodiment of FIG. 5B the best linear fit 56b is according to Equation 5 provided below,

$$y = - 0.0365 x + 23.932 \qquad ( Equation 5 )$$

In Equation 5, “y” denotes the optical reflectance of the Sample B for the p-polarized incident light 21a at the incident angle θ of at least 40 degrees in the incident plane 22 that includes the first direction, and “x” denotes the wavelength. Further, the magnitude of the slope 58b=0.0365 or 3.65%/nm, and R5=0.9986.

Since the reflection band edge 54b is a sharp band edge, the reflection band edge 54b may substantially separate a wavelength range extending from about 380 nm to about 636 nm from another wavelength range extending from about 652 nm to about 1180 nm. The slope 58b of the best linear fit 56b of about 3.65%/nm may provide a sharp cut-off between wavelength ranges that the reflection band edge 54b separates. The sharp cut-off, in turn, may reduce leakages of the incident light 21a between the two wavelength ranges. In other words, the Sample B may provide a high contrast.

From the plots 300, 400, 500, it can be observed that the Samples A, B and C of the multilayer optical film 10 may substantially reflect the p-polarized incident lights 20a, 21a for the at least the first wavelength 33 in the first wavelength range 30 and substantially transmit the s-polarized incident lights 20b, 21b for the at least the first wavelength 33 in the first wavelength range 30. Therefore, the Samples A, B and C of the multilayer optical film 10 may be reflective polarizers.

Further, it may be observed that the reflection band edges 50a, 54a of the Sample A, the reflection band edges 50b, 54b of the Sample B, and the reflection band edge 50c of the Sample C of the multilayer optical film 10 separate different ranges of wavelengths. In other words, the Samples A, B, C of the multilayer optical film 10 have different cut-off locations for separating corresponding different wavelength ranges. Therefore, the cut-off location of the multilayer optical film 10 may be adjusted as per desired application attributes.

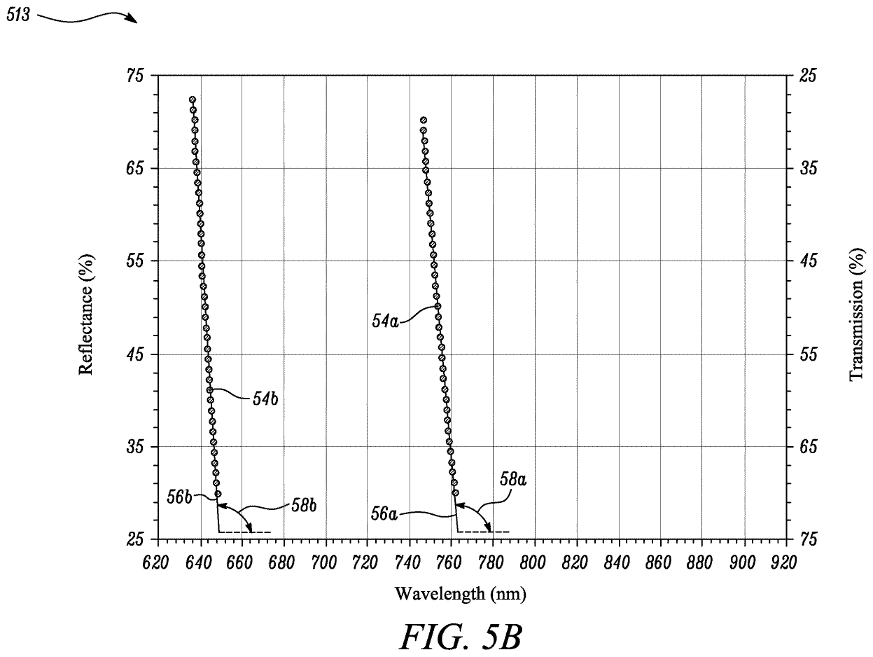

FIG. 6 illustrates another plot 600 depicting optical characteristics of the multilayer optical film 10 for the substantially normally incident light 20a (shown in FIG. 2A) polarized along the first direction, according to an embodiment of the present disclosure. Specifically, the plot 600 depicts optical absorbances of the plurality of alternating first and second polymeric layers 11, 12 of the Samples A, B and C (described with reference to FIG. 1A and the respective Tables 1, 2, 3) of the multilayer optical film 10. Wavelength is expressed in nanometers (nm) in the abscissa. Optical absorbance is expressed as an absorbance percentage in the left ordinate axis.

Referring now to FIGS. 1A, 2A and 6, the plot 600 illustrates curves 601, 602, 603 corresponding to optical absorbances of the respective Samples A, B and C for the substantially normally incident light 20a polarized along the first direction.

As can be observed from the curves 601, 602, 603, for the substantially normally incident light 20a polarized along the first direction, the plurality of alternating first and second polymeric layers 11, 12 has an average optical absorbance ABS1 for a second wavelength range 40 extending from about 380 nm to about 400 nm. Specifically, for the substantially normally incident light 20a polarized along the first direction, the plurality of alternating first and second polymeric layers 11, 12 has the average optical absorbance of less than about 1% for the second wavelength range 40.

In some embodiments, for the substantially normally incident light 20a polarized along the first direction, the plurality of alternating first and second polymeric layers 11, 12 has the average optical absorbance of less than about 0.9%, less than about 0.8%, less than about 0.7%, less than about 0.6%, less than about 0.5%, less than about 0.4%, less than about 0.3%, less than about 0.2%, or less than about 0.15% for the second wavelength range 40.

In some examples, for the substantially normally incident light 20a polarized along the first direction, the plurality of alternating first and second polymeric layers 11, 12 has the average optical absorbance of about 0.5%, or about 0.44% for the second wavelength range 40.

Further, in some embodiments, for the substantially normally incident light 20a polarized along the first direction, the plurality of alternating first and second polymeric layers 11, 12 has an average optical absorbance ABS2 for a third wavelength range 42 extending from about 380 nm to about 450 nm.

In some embodiments, a ratio of ABS1 to ABS2 is less than or equal to about 2.5, i.e., (ABS1/ABS2)≤2.5. In some embodiments, (ABS1/ABS2)≤2.4, (ABS1/ABS2)≤2.3, (ABS1/ABS2)≤2.2, (ABS1/ABS2)≤2.1, or (ABS1/ABS2)≤2. In some other examples, (ABS1/ABS2) is about 1.9.

Therefore, from the curves 601, 602, 603, it may be inferred that the Samples A, B, C of the multilayer optical film 10 may have very low optical absorbances for the incident light 20a in the second wavelength range 40. Further, the Samples A, B, C of the multilayer optical film 10 may have even lower average optical absorbance for the incident light 20a in the third wavelength range 42 as compared to the second wavelength range 40.

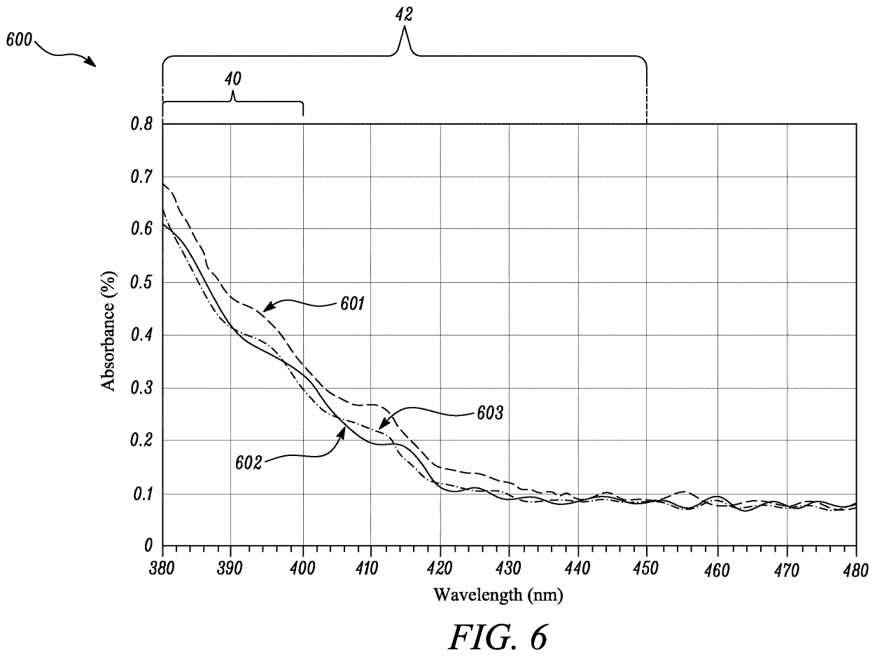

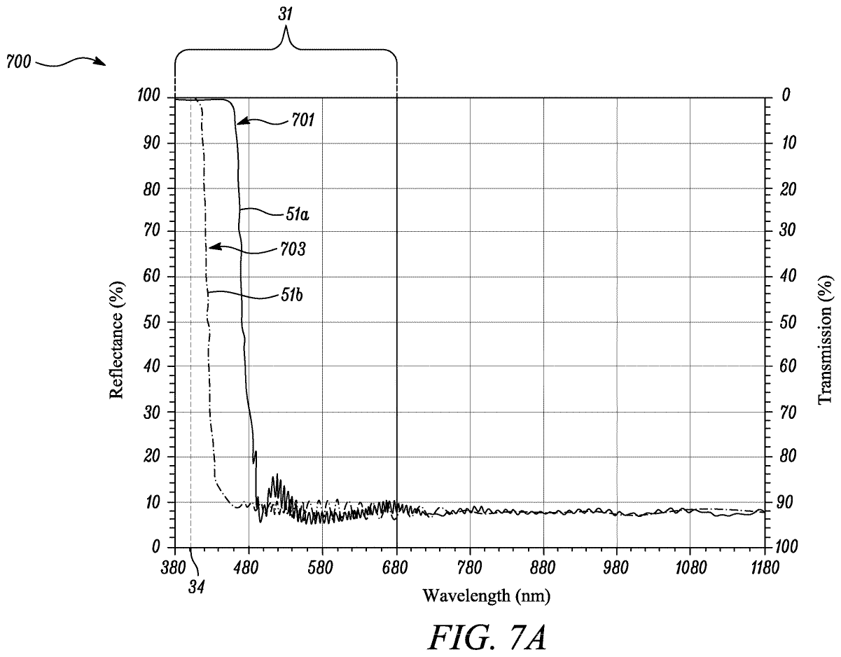

FIG. 7A illustrates another plot 700 depicting optical characteristics of the multilayer optical film 10 for the substantially normally incident lights 20a, 20b (shown in FIGS. 2A and 2B), according to an embodiment of the present disclosure. Specifically, the plot 700 depicts optical reflectances of the plurality of alternating first and second polymeric layers 11, 12 of the Samples D and E (described with reference to FIG. 1A and the respective Tables 4, 5) of the multilayer optical film 10. Wavelength is expressed in nanometers (nm) in the abscissa. Optical reflectance is expressed as a reflectance percentage in the left ordinate axis. Optical transmission is expressed as a transmission percentage on the right ordinate axis. Transmission percentage is approximated to be complementary to the reflectance percentage, i.e., transmission percentage=(100−reflectance percentage).

Referring to FIGS. 1A, 2A-2B and 7A, the plot 700 includes a curve 701 corresponding to an optical reflectance of the Sample D for the substantially normally incident light 20a polarized along the first direction. The curve 701 may interchangeably be referred to as “the optical reflectance of the plurality of alternating first and second polymeric layers versus wavelength 701”, or “the optical reflectance versus wavelength 701” of the Sample D. The optical reflectance versus wavelength 701 illustrates a variation of the optical reflectance of the plurality of alternating first and second polymeric layers 11, 12 of the Sample D with wavelength for the substantially normally incident light 20a polarized along the first direction.

As can be observed from the curve 701, for the substantially normally incident light 20a polarized along the first direction, the plurality of alternating first and second polymeric layers 11, 12 of the Sample D reflects greater than about 80% of the incident light 20a for at least a first wavelength 34 in a first wavelength range 31 extending from about 380 nm to about 680 nm. In some examples, for the substantially normally incident p-polarized incident light 20a, the plurality of alternating first and second polymeric layers 11, 12 of the Sample D reflects greater than about 80% of the incident light 20a for the at least the first wavelength 34 in the first wavelength range 31. Therefore, for the substantially normally incident light 20a polarized along the first direction, the Sample D substantially reflects the incident light 20a for the at least the first wavelength 34 in the first wavelength range 31.

In the illustrated embodiment of FIG. 7A, for the substantially normally incident light 20a polarized along the first direction, the Sample D reflects about 99% of the incident light 20a for the first wavelength 34 of about 400 nm.

Further, as can be observed from the plot 700, for the substantially normally incident light 20a polarized along the first direction, the optical reflectance versus wavelength 701 includes a reflection band edge 51a along which the optical reflectance of the Sample D generally decreases with increasing wavelength.

In some embodiments, the curve 701 also corresponds to the optical reflectance of the Sample D for the substantially normally incident light 20b polarized along the second direction. Therefore, for the substantially normally incident light 20b polarized along the second direction, the plurality of alternating first and second polymeric layers 11, 12 of the Sample D reflects greater than about 70% of the incident light 20b for the at least the first wavelength 34 in the first wavelength range 31. In some examples, for the substantially normally incident s-polarized incident light 20b, the plurality of alternating first and second polymeric layers 11, 12 of the Sample D reflects greater than about 70% of the incident light 20b for the at least the first wavelength 34 in the first wavelength range 31. In some embodiments, for the substantially normally incident light 20b polarized along the second direction, the plurality of alternating first and second polymeric layers 11, 12 of the Sample D reflects greater than about 75%, greater than about 80%, greater than about 85%, greater than about 95%, or greater than about 98% of the incident light 20b for the at least the first wavelength 34 in the first wavelength range 31.

In some embodiments, for the substantially normally incident light 20b polarized along the in-plane second direction orthogonal to the first direction and for the at least the first wavelength 34 in the first wavelength range 31, the plurality of alternating first and second polymeric layers 11, 12 of the Sample D reflects greater than about 60% of the incident light 20b. In some embodiments, for the substantially normally incident light 20b polarized along the in-plane second direction orthogonal to the first direction and for the at least the first wavelength 34 in the first wavelength range 31, the plurality of alternating first and second polymeric layers 11, 12 of the Sample D reflects greater than about 70%, greater than about 80%, or greater than about 90% of the incident light 20b.

Therefore, for the substantially normally incident light 20b polarized along the second direction, the Sample D substantially reflects the incident light 20b for the at least the first wavelength 34 in the first wavelength range 31.

In the illustrated embodiment of FIG. 7A, for the substantially normally incident light 20b polarized along the second direction, the Sample D reflects about 99% of the incident light 20b for the first wavelength 34 of about 400 nm.

Since the Sample D substantially reflects the incident lights 20a, 20b polarized along the respective first and second directions for the first wavelength 34 of about 400 nm, the Sample D may be an optical mirror.

Referring to FIGS. 1A, 2A-2B and 7A, the plot 700 further includes a curve 703 corresponding to an optical reflectance of the Sample E for the substantially normally incident light 20a polarized along the first direction. The curve 703 may interchangeably be referred to as “the optical reflectance of the plurality of alternating first and second polymeric layers versus wavelength 703”, or “the optical reflectance versus wavelength 703” of the Sample E. The optical reflectance versus wavelength 703 illustrates a variation of the optical reflectance of the plurality of alternating first and second polymeric layers 11, 12 of the Sample E with wavelength for the substantially normally incident light 20a polarized along the first direction.

As can be observed from the curve 703, for the substantially normally incident light 20a polarized along the first direction, the plurality of alternating first and second polymeric layers 11, 12 of the Sample E reflects greater than about 80% of the incident light 20a for the at least the first wavelength 34 in the first wavelength range 31. In some examples, for the substantially normally incident p-polarized incident light 20a, the plurality of alternating first and second polymeric layers 11, 12 of the Sample E reflects greater than about 80% of the incident light 20a for the at least the first wavelength 34 in the first wavelength range 31. Therefore, for the substantially normally incident light 20a polarized along the first direction, the Sample E substantially reflects the incident light 20a for the at least the first wavelength 34 in the first wavelength range 31.

In the illustrated embodiment of FIG. 7A, for the substantially normally incident light 20a polarized along the first direction, the Sample E reflects about 99% of the incident light 20a for the first wavelength 34 of about 400 nm.

Further, as can be observed from the plot 700, for the substantially normally incident light 20a polarized along the first direction, the optical reflectance versus wavelength 703 includes a reflection band edge 51b along which the optical reflectance of the Sample E generally decreases with increasing wavelength.

In some embodiments, the curve 703 also corresponds to the optical reflectance of the Sample E for the substantially normally incident light 20b polarized along the second direction. Therefore, for the substantially normally incident light 20b polarized along the second direction, the plurality of alternating first and second polymeric layers 11, 12 of the Sample E reflects greater than about 70% of the incident light 20b for the at least the first wavelength 34 in the first wavelength range 31. In some examples, for the substantially normally incident s-polarized incident light 20b, the plurality of alternating first and second polymeric layers 11, 12 of the Sample E reflects greater than about 70% of the incident light 20b for the at least the first wavelength 34 in the first wavelength range 31. Therefore, for the substantially normally incident light 20b polarized along the second direction, the Sample E substantially reflects the incident light 20b for the at least the first wavelength 34 in the first wavelength range 31.

In the illustrated embodiment of FIG. 7A, for the substantially normally incident light 20b polarized along the second direction, the Sample E reflects about 99% of the incident light 20b for the first wavelength 34 of about 400 nm.

Since the Sample E substantially reflects the incident lights 20a, 20b polarized along the respective first and second directions for the first wavelength 34 of about 400 nm, the Sample E may be an optical mirror.

FIG. 7B illustrates a plot 713 depicting best linear fits 51c and 51d corresponding to the reflection band edges 51a and 51b of the respective optical reflectances versus wavelength 701, 703 (shown in FIG. 7A), according to an embodiment of the present disclosure. Specifically, the best linear fit 51c to the reflection band edge 51a is at least across a wavelength range along the reflection band edge 51a where the optical reflectance decreases from about 70% to about 30%. The best linear fit 51d to the reflection band edge 51b is at least across a wavelength range along the reflection band edge 51b where the optical reflectance decreases from about 70% to about 30%.

The best linear fit 51c to the reflection band edge 51a has a negative slope 53a and an r-squared value R6. In some embodiments, the best linear fit 51c to the reflection band edge 51a at least across the wavelength range along the reflection band edge 51a where the optical reflectance decreases from about 70% to about 30% has the negative slope 53a having a magnitude of greater than about 1%/nm. In the illustrated embodiment of FIG. 7B, the best linear fit 51c is according to Equation 6 provided below,

$$y = - 0.0449 x + 21.728 \qquad ( Equation 6 )$$

In Equation 6, “y” denotes the optical reflectance of the Sample D for the substantially normally incident light 20a polarized along the first direction, and “x” denotes the wavelength. Further, the magnitude of the slope 53a=0.0449 or 4.49%/nm, and R6=0.9788.

Since the reflection band edge 51a is a sharp band edge, the reflection band edge 51a may substantially separate a wavelength range extending from about 380 nm to about 465 nm from another wavelength range extending from about 480 nm to about 1180 nm. The slope 53a of the best linear fit 51c of about 4.49%/nm may provide a sharp cut-off between wavelength ranges that the reflection band edge 51a separates. The sharp cut-off, in turn, may reduce leakage of the incident light 20a between the two wavelength ranges. In other words, the Sample D may provide a high contrast.

The best linear fit 51d to the reflection band edge 51b has a negative slope 53b and an r-squared value R7. In some embodiments, the best linear fit 51d to the reflection band edge 51b at least across the wavelength range along the reflection band edge 51b where the optical reflectance decreases from about 70% to about 30% has the negative slope 53b having a magnitude of greater than about 1%/nm. In the illustrated embodiment of FIG. 7B, the best linear fit 51d is according to Equation 7 provided below,

$$y = - 0.0563 x + 24.442 \qquad ( Equation 7 )$$

In Equation 7, “y” denotes the optical reflectance of the Sample E for the substantially normally incident light 20a polarized along the first direction, and “x” denotes the wavelength. Further, the magnitude of the slope 53b=0.0563 or 5.63%/nm, and R7=0.9992.

Since the reflection band edge 51b is a sharp band edge, the reflection band edge 51b may substantially separate a wavelength range extending from about 380 nm to about 420 nm from another wavelength range extending from about 430 nm to about 1180 nm. The slope 53b of the best linear fit 51d of about 5.63%/nm may provide a sharp cut-off between wavelength ranges that the reflection band edge 51b separates. The sharp cut-off, in turn, may reduce leakages of the incident light 20a between the two wavelength ranges. In other words, the Sample E may provide a high contrast.

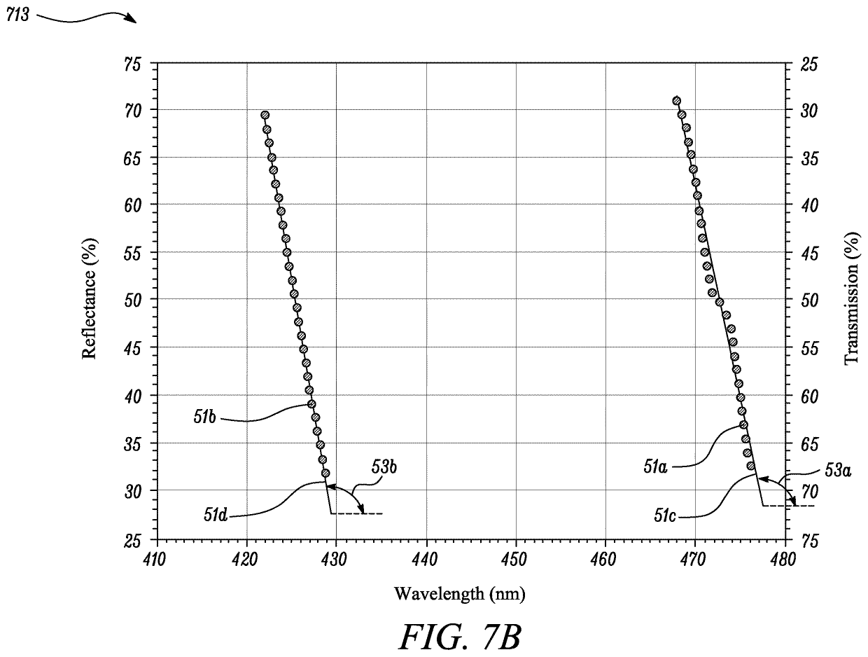

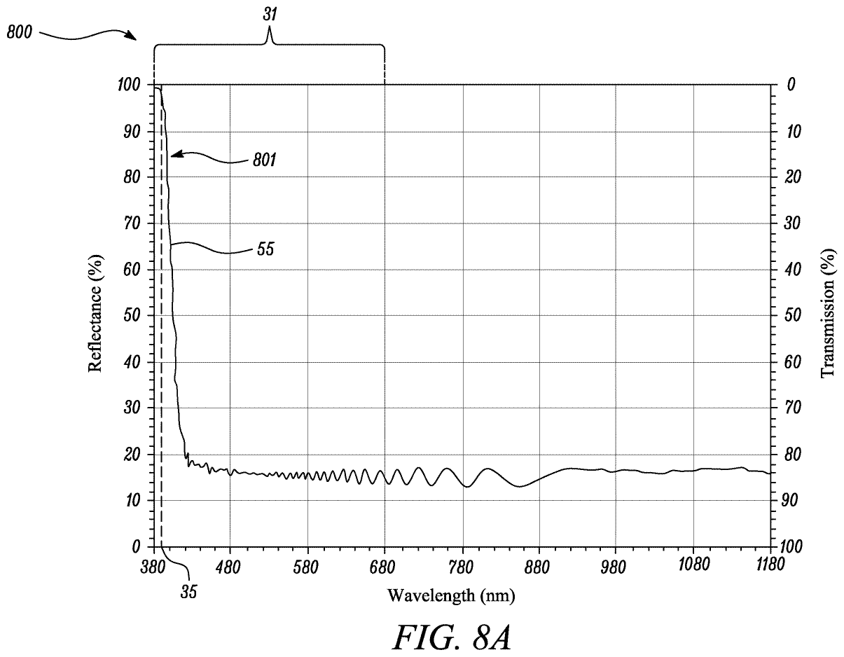

FIG. 8A illustrates another plot 800 depicting optical characteristics of the multilayer optical film 10 for the incident lights 21a, 21b (shown in FIGS. 2A and 2B) incident at the incident angle θ, according to an embodiment of the present disclosure. Specifically, the plot 800 depicts optical reflectances of the plurality of alternating first and second polymeric layers 11, 12 of the Sample D (described with reference to FIG. 1A and Table 4) of the multilayer optical film 10. Wavelength is expressed in nanometers (nm) in the abscissa. Optical reflectance is expressed as a reflectance percentage in the left ordinate axis. Optical transmission is expressed as a transmission percentage on the right ordinate axis. Transmission percentage is approximated to be complementary to the reflectance percentage, i.e., transmission percentage=(100−reflectance percentage).

Referring to FIGS. 1A, 2A-2B and 8A, the plot 800 includes a curve 801 corresponding to an optical reflectance of the Sample D for the p-polarized incident light 21a at the incident angle θ of at least 40 degrees in the incident plane 22 that includes the first direction. The curve 801 may interchangeably be referred to as “the optical reflectance of the plurality of alternating first and second polymeric layers versus wavelength 801”, or “the optical reflectance versus wavelength 801” of the Sample D. The optical reflectance versus wavelength 801 illustrates a variation of the optical reflectance of the plurality of alternating first and second polymeric layers 11, 12 of the Sample D with wavelength for the p-polarized incident light 21a incident at the incident angle θ of at least 40 degrees.

As can be observed from the curve 801, in some embodiments, for the p-polarized incident light 21a at the incident angle θ of at least 40 degrees in the incident plane 22 that includes the first direction, the plurality of alternating first and second polymeric layers 11, 12 reflects greater than about 80% of the incident light 21a for at least a first wavelength 35 in the first wavelength range 31. Therefore, for the p-polarized incident light 21a at the incident angle θ of at least 40 degrees in the incident plane 22 that includes the first direction, the Sample D substantially reflects the incident light 21a for the at least the first wavelength 35 in the first wavelength range 31.

In the illustrated embodiment of FIG. 8A, for the p-polarized incident light 21a at the incident angle θ of about 60 degrees in the incident plane 22 that includes the first direction, the Sample D reflects about 90% of the incident light 21a for the first wavelength 35 of about 390 nm.

Further, as can be observed from the plot 800, for the p-polarized incident light 21a at the incident angle θ of at least 40 degrees in the incident plane 22 that includes the first direction, the optical reflectance versus wavelength 801 includes a reflection band edge 55 along which the optical reflectance of the Sample D generally decreases with increasing wavelength.

In some embodiments, the curve 801 also corresponds to the optical reflectance of the Sample D for the s-polarized incident light 21b incident at the incident angle θ of at least 40 degrees. Therefore, for the s-polarized incident light 21b incident at the incident angle θ of at least 40 degrees, the plurality of alternating first and second polymeric layers 11, 12 reflects greater than about 70% of the incident light 21b for the at least the first wavelength 35 in the first wavelength range 31. Thus, for the s-polarized incident light 21b incident at the incident angle θ of at least 40 degrees, the Sample D substantially reflects the incident light 21b for the at least the first wavelength 35 in the first wavelength range 31.

In the illustrated embodiment of FIG. 8A, for the s-polarized incident light 21b incident at the incident angle θ of at least 40 degrees, the Sample D reflects about 90% of the incident light 21b for the first wavelength 35 of about 390 nm.

FIG. 8B illustrates a plot 813 depicting a best linear fit 57a to the reflection band edge 55 of the optical reflectance versus wavelength 801 (shown in FIG. 8A), according to an embodiment of the present disclosure. Specifically, the best linear fit 57a to the reflection band edge 55 is at least across a wavelength range along the reflection band edge 55 where the optical reflectance decreases from about 70% to about 30%.

The best linear fit 57a to the reflection band edge 55 has a negative slope 57b and an r-squared value R8. In some embodiments, the best linear fit 57a to the reflection band edge 55 at least across the wavelength range along the reflection band edge 55 where the optical reflectance decreases from about 70% to about 30% has the negative slope 57b having a magnitude of greater than about 2%/nm. In the illustrated embodiment of FIG. 8B, the best linear fit 57a is according to Equation 8 provided below,

$$y = - 0.0354 x + 14.804 \qquad ( Equation 8 )$$

In Equation 8, “y” denotes the optical reflectance of the Sample D for the p-polarized incident light 21a at the incident angle θ of at least 40 degrees in the incident plane 22 that includes the first direction, and “x” denotes the wavelength. Further, the magnitude of the slope 57b=0.0354 or 3.54%/nm, and R8=0.9793.

Since the reflection band edge 55 is a sharp band edge, the reflection band edge 55 may substantially separate a wavelength range extending from about 380 nm to about 398 nm from another wavelength range extending from about 410 nm to about 1180 nm. The slope 57b of the best linear fit 57a of about 3.54%/nm may provide a sharp cut-off between wavelength ranges that the reflection band edge 55 separates. The sharp cut-off, in turn, may reduce leakages of the incident light 21a between the two wavelength ranges. In other words, the Sample D may provide a high contrast.

From plots 700, 800, it can be observed that the Samples D and E of the multilayer optical film 10 substantially reflect both the p-polarized incident lights 20a, 21a and the s-polarized incident lights 20b, 21b for the at least the first wavelength 34, 35 in the first wavelength range 31. In other words, the Samples D and E substantially reflect an incident light in a wavelength range irrespective of a polarization state of the incident light. Therefore, the Samples D and E of the multilayer optical film 10 may be mirrors or partial mirrors.

Further, it may be observed that, the respective reflection band edges 51a, 55 of the Sample D, and reflection band edge 51b of the Sample E of the multilayer optical film 10 separate different ranges of wavelengths. In other words, the Samples D, E of the multilayer optical film 10 have different cut-off locations for separating corresponding different wavelength ranges. Therefore, the cut-off location of the multilayer optical film 10 may be adjusted as per desired application attributes.

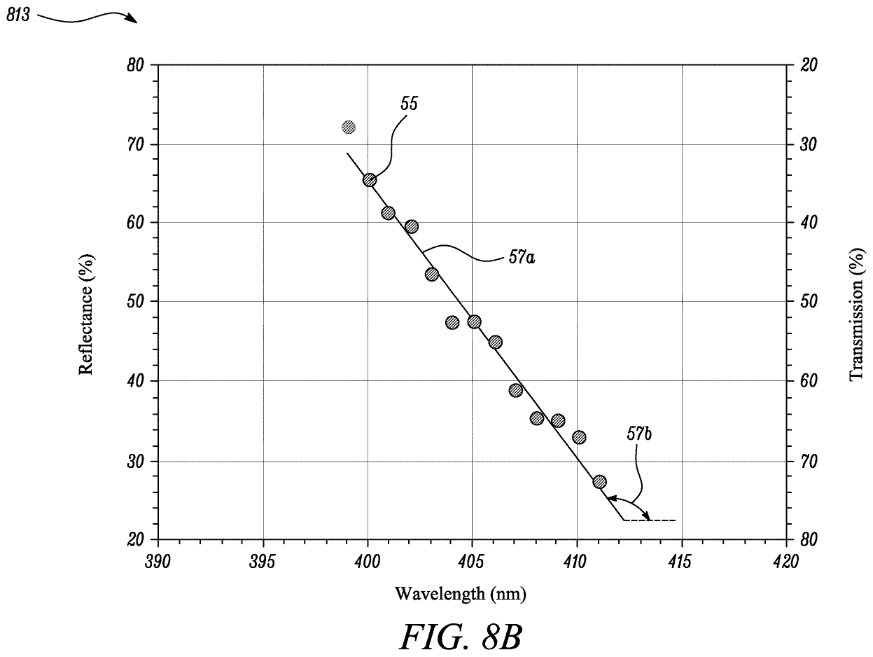

FIG. 9 illustrates another plot 900 depicting optical characteristics of the of the multilayer optical film 10 for the substantially normally incident light 20a (shown in FIG. 2A) polarized along the first direction, according to an embodiment of the present disclosure. Specifically, the plot 900 depicts optical absorbances of the plurality of alternating first and second polymeric layers 11, 12 of the Samples D, E (described with reference to FIG. 1A and respective Tables 4, 5) of the multilayer optical film 10. Wavelength is expressed in nanometers (nm) in the abscissa. Optical absorbance is expressed as an absorbance percentage in the left ordinate axis.

Referring now to FIGS. 1A, 2A and 9, the plot 900 illustrates curves 901, 902 corresponding to optical absorbances of the respective Samples D, E for the substantially normally incident light 20a polarized along the first direction.

As can be observed from the curves 901, 902, for the substantially normally incident light 20a polarized along the first direction, the plurality of alternating first and second polymeric layers 11, 12 has an average optical absorbance ABS3 for a second wavelength range 41 extending from about 380 nm to about 400 nm. Specifically, for the substantially normally incident light 20a polarized along the first direction, the plurality of alternating first and second polymeric layers 11, 12 has the average optical absorbance of less than about 1% for the second wavelength range 41.

In some embodiments, for the substantially normally incident light 20a polarized along the first direction, the plurality of alternating first and second polymeric layers 11, 12 has the average optical absorbance of less than about 0.9%, less than about 0.8%, less than about 0.7%, less than about 0.6%, less than about 0.5%, less than about 0.4%, less than about 0.3%, less than about 0.2%, or less than about 0.15% for the second wavelength range 41.

In some examples, for the substantially normally incident light 20a polarized along the first direction, the plurality of alternating first and second polymeric layers 11, 12 has the average optical absorbance of about 0.12% for the second wavelength range 41.

Further, in some embodiments, for the substantially normally incident light 20a polarized along the first direction, the plurality of alternating first and second polymeric layers 11, 12 has an average optical absorbance ABS4 for a third wavelength range 44 extending from about 380 nm to about 450 nm.

In some embodiments, a ratio of ABS3 to ABS4 is less than or equal to about 2.5, i.e., (ABS3/ABS4)≤2.5. In some embodiments, (ABS3/ABS4)≤2.4, (ABS3/ABS4)≤2.3, (ABS3/ABS4)≤2.2, (ABS3/ABS4)≤2.1, or (ABS3/ABS4)≤2. In some other examples, (ABS3/ABS4) is about 1.2, or about 1.4.

Therefore, from the curves 901, 902, it may be inferred that the Samples D, E of the multilayer optical film 10 may have very low optical absorbances for the incident light 20a in the second wavelength range 41. Further, the Samples D, E of the multilayer optical film 10 may have even lower average optical absorbance for the incident light 20a in the third wavelength range 44 as compared to the second wavelength range 41.

Referring to FIGS. 1-9, for the substantially normally incident light 20a polarized along the first direction, the plurality of alternating first and second polymeric layers 11, 12 reflects greater than about 80% of the incident light 20a for the at least the first wavelength 33, 34 in the first wavelength range 30, 31. Further, for the substantially normally incident light 20a polarized along the first direction, the plurality of alternating first and second polymeric layers 11, 12 has the average optical absorbance of less than about 1% for the second wavelength range 40, 41.

In some embodiments, for the substantially normally incident light 20a polarized along the first direction, the optical reflectance versus wavelength 301, 401, 402, 701, 702 includes the reflection band edge 50a, 50b, 50c, 51a, 51b along which the optical reflectance generally decreases with increasing wavelength. The best linear fit 50d, 50e, 50f, 51c, 51d to the reflection band edge 50a, 50b, 50c, 51a, 51b at least across the wavelength range along the reflection band edge 50a, 50b, 50c, 51a, 51b where the optical reflectance decreases from about 70% to about 30% has the negative slope 52a, 52b, 52c, 53a, 53b having the magnitude of greater than about 1%/nm.

In some embodiments, for the substantially normally incident light 20a polarized along the first direction, the plurality of alternating first and second polymeric layers 11, 12 has the average optical absorbance ABS1, ABS3 for the second wavelength range 40, 41 and the average optical absorbance ABS2, ABS4 for the third wavelength range 42, 44, ABS1/ABS2≤2.5, ABS3/ABS4≤2.5.

In some embodiments, for the p-polarized incident light 21a at the incident angle θ in the incident plane 22 that includes the first direction, the optical reflectance versus wavelength 501, 502, 801 includes the reflection band edge 54a, 54b, 55 along which the optical reflectance generally decreases with increasing wavelength. The best linear fit 56a, 56b, 57a to the reflection band edge 54a, 54b, 55 at least across the wavelength range along the reflection band edge 54a, 54b, 55 where the optical reflectance decreases from about 70% to about 30% has the negative slope 58a, 58b, 57b having the magnitude of greater than about 2%/nm.

In some embodiments, for the substantially normally incident light 20b polarized along the second direction and for the at least the first wavelength 33 in the first wavelength range 30, the plurality of alternating first and second polymeric layers 11, 12 transmits greater than about 60% of the incident light 20b.

In some embodiments, for the substantially normally incident light 20b polarized along the second direction and for the at least the first wavelength 34 in the first wavelength range 31, the plurality of alternating first and second polymeric layers 11, 12 reflects greater than about 60% of the incident light 20b.

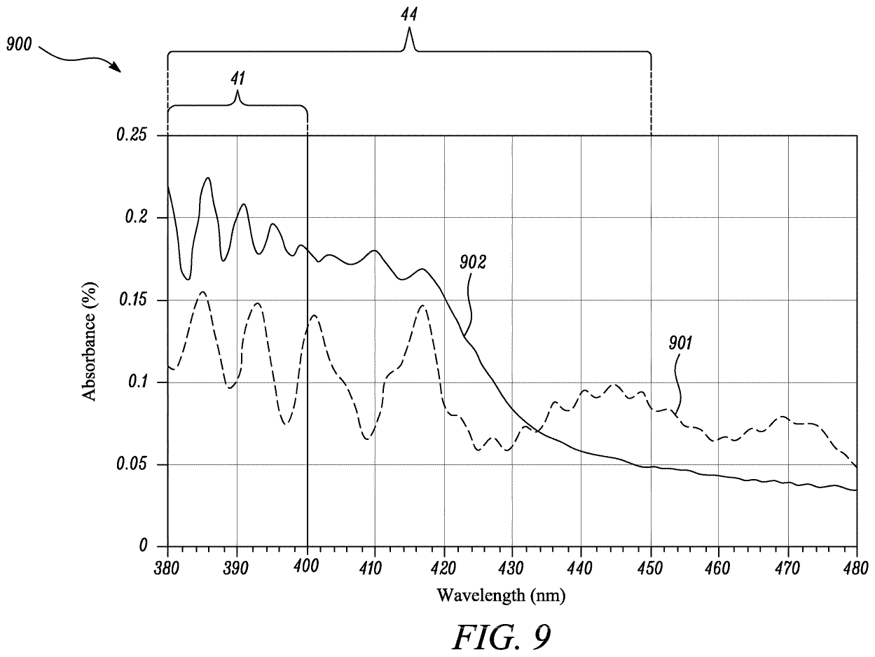

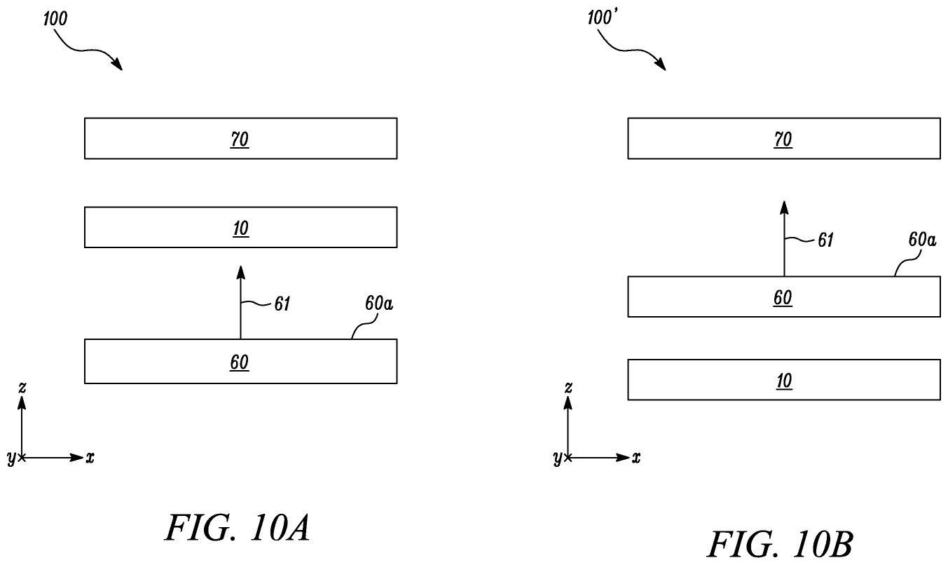

FIG. 10A illustrates a detailed schematic sectional view of a display system 100, according to an embodiment of the present disclosure.

The display system 100 includes an extended light source 60 configured to emit a light 61 from an emission surface 60a thereof. In some embodiments, the display system 100 further includes a display panel 70 configured to receive the light 61 emitted from the emission surface 60a.

The display system 100 further includes the multilayer optical film 10 disposed on the extended light source 60. In some embodiments, the multilayer optical film 10 is disposed on an emission surface side of the extended light source 60. In some embodiments, the multilayer optical film 10 is disposed between the display panel 70 and the emission surface 60a.

In the illustrated embodiment of FIG. 10A, the multilayer optical film 10 may act as a reflective polarizer (e.g., the Samples A, B, C described with reference to FIG. 1A and respective Tables 1, 2, 3), where the multilayer optical film 10 may selectively substantially reflect an incident light having one polarization (such as p-polarization) and substantially transmit the incident light having an orthogonal polarization (such as s-polarization) for a given wavelength.

FIG. 10B illustrates a detailed schematic sectional view of a display system 100′, according to another embodiment of the present disclosure. The display system 100′ is substantially similar to the display system 100 of FIG. 10A. Common elements are referenced by the same reference numerals. However, in the display system 100′, the multilayer optical film 10 is disposed on the extended light source 60 opposite the emission surface 60a. In some embodiments, the emission surface 60a is disposed between the display panel 70 and the multilayer optical film 10.

In the illustrated embodiment of FIG. 10B, the multilayer optical film 10 may act as a mirror or partial mirror (e.g., the Samples D, E described with reference to FIG. 1A and respective Tables 4, 5), where the multilayer optical film 10 may substantially reflect an incident having both polarizations (such as p- and s-polarizations). Further, the multilayer optical film 10 may be configured as a back reflector to the extended light source 60 and may reflect a light incident on it towards the extended light source 60 in order to recycle the light.

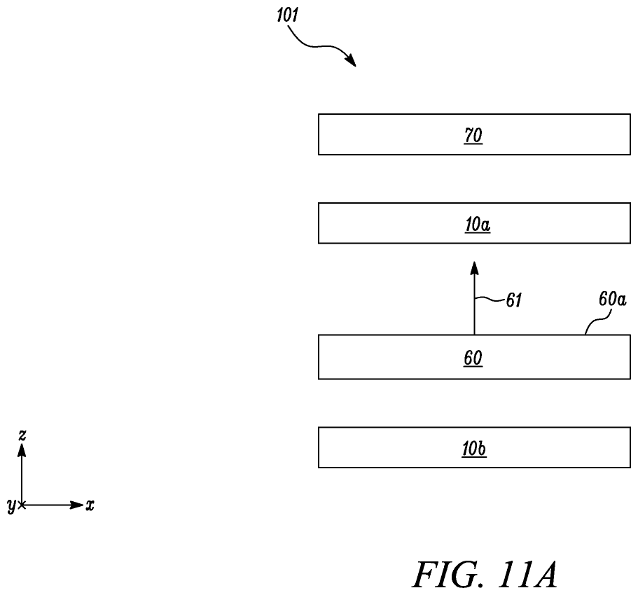

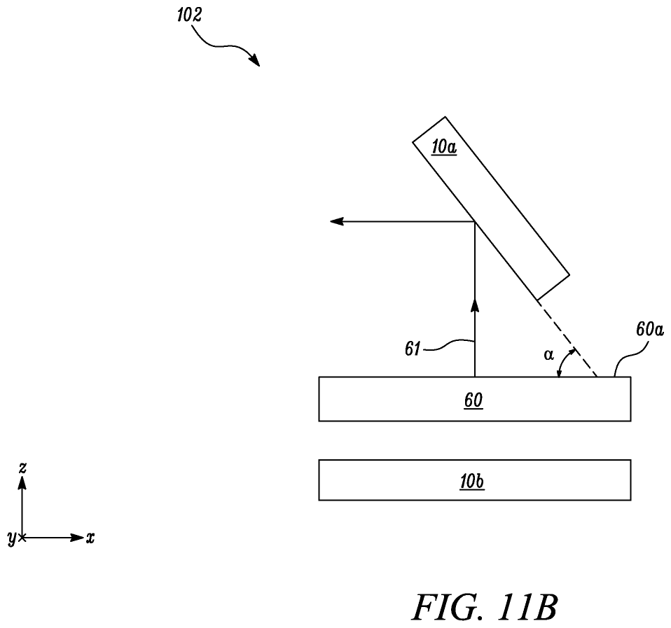

FIG. 11A illustrates a detailed schematic sectional view of a display system 101, according to an embodiment of the present disclosure. The display system 101 is substantially similar to the display system 100 of FIG. 10A. Common elements are referenced by the same reference numerals. However, the display system 101 includes two multilayer optical films 10 as shown in FIG. 1. Specifically, the display system 101 includes first and second multilayer optical films 10a, 10b disposed on opposite sides of the extended light source 60. The first multilayer optical film 10a generally faces the emission surface 60a and the second multilayer optical film 10b generally faces away from the emission surface 60a. In some embodiments, the emission surface 60a, and the first and second multilayer optical films 10a, 10b are substantially parallel and co-extensive in length and width with each other. In some embodiments, the first and second multilayer optical films 10a, 10b may define an optical recycling cavity therebetween.

Referring to FIGS. 1A, 2A-2B and 11A, for the substantially normally incident light 20b polarized along the in-plane second direction orthogonal to the first direction, and for the at least the first wavelength 33 in the first wavelength range 30 (shown in FIG. 3A), the plurality of alternating first and second polymeric layers 11, 12 of the first multilayer optical film 10a transmits greater than about 60% of the incident light 20b. In other words, for the substantially normally incident s-polarized incident light 20b, and for the at least the first wavelength 33 in the first wavelength range 30, the plurality of alternating first and second polymeric layers 11, 12 of the first multilayer optical film 10a transmits greater than about 60% of the incident light 20b. Therefore, for the substantially normally incident light 20b polarized along the in-plane second direction orthogonal to the first direction, the first multilayer optical film 10a substantially transmits the incident light 20b for the at least the first wavelength 33 in the first wavelength range 30. In some embodiments, for the substantially normally incident light 20b polarized along the in-plane second direction, and for at least the first wavelength 33 in the first wavelength range 30, the plurality of alternating first and second polymeric layers 11, 12 of the first multilayer optical film 10a transmits greater than about 70%, greater than about 80%, or greater than about 90% of the incident light 20b.

Further, for the substantially normally incident light 20b polarized along the in-plane second direction orthogonal to the first direction and for the at least the first wavelength 34 in the first wavelength range 31, the plurality of alternating first and second polymeric layers 11, 12 of the second multilayer optical film 10b reflects greater than about 60% of the incident light 20b. In other words, for the substantially normally incident s-polarized incident light 20b, and for at least the first wavelength 34 in the first wavelength range 31, the plurality of alternating first and second polymeric layers 11, 12 of the second multilayer optical film 10b reflects greater than about 60% of the incident light 20b. Therefore, for the substantially normally incident light 20b polarized along the in-plane second direction, the second multilayer optical film 10b substantially reflects the incident light 20b for the at least the first wavelength 34 in the first wavelength range 31. In some embodiments, for the substantially normally incident light 20b polarized along the in-plane second direction, and for the at least the first wavelength 34 in the first wavelength range 31, the plurality of alternating first and second polymeric layers 11, 12 of the second multilayer optical film 10b reflects greater than about 70%, greater than about 80%, or greater than about 90% of the incident light 20b.

Therefore, in the display system 101, the first multilayer optical film 10a may act as a reflective polarizer (e.g., the Samples A, B, C described with reference to FIG. 1A and the respective Tables 1, 2, 3) that selectively and substantially transmits a substantially normally incident light polarized along the second direction (e.g., the incident light 20b) for a given wavelength. Further, in the display system 101, the second multilayer optical film 10b may act as a mirror or partial mirror (e.g., the Samples D, E described with reference to FIG. 1A and the respective Tables 4, 5) that substantially reflects a substantially normally incident light polarized along the second direction (e.g., the incident light 20b) in a given wavelength.

FIG. 11B illustrates a detailed schematic sectional view of a display system 102, according to another embodiment of the present disclosure.

The display system 102 is substantially similar to the display system 101 of FIG. 11A. Common elements are referenced by the same reference numerals. However, in the display system 102, the emission surface 60a makes an angle α of between about 20 degrees and 70 degrees with the first multilayer optical film 10a. Specifically, the emission surface 60a makes the angle α of between about 20 degrees and 70 degrees with an outer surface (e.g., the first and second major surfaces 110, 111) of the first multilayer optical film 10a.

FIG. 12A illustrates a schematic side view of an example of the vehicle 1200 having the windshield 1205. The vehicle 1200 may include any navigable vehicle that may be operated on a road surface, and includes, without limitation, cars, buses, motorcycles, off-road vehicles, and trucks. In some other embodiments, the vehicle 1200 may also include water vehicles and aircrafts. The windshield 1205 may include any of a wide variety of transparent members, and can be unitary or laminated, flat or curved (simple or compound curvature), water clear or tinted, can have focusing properties, and can be composed of any conventional glasses and/or plastics. In some cases, the windshield 1205 may include a sheet of glass or other transparent material with two opposing surfaces.

FIG. 12B illustrates a schematic view of an example display system 1210 for the windshield 1205 of the vehicle 1200 (shown in FIG. 12A). The display system 1210 is used for displaying a virtual image 1212 to a passenger 1211 of the vehicle 1200. In some embodiments, the display system 1210 is a HUD. The display system 1210 displays information to the passenger 1211 of the vehicle 1200. The passenger 1211 may be a driver of the vehicle 1200. The display system 1210 displays the information in the passenger's view, so that the passenger 1211 may not need to look away from the windshield 1205 while driving, to see the information displayed. The display system 1210 of the vehicle 1200, as disclosed in the present disclosure, may be configured to, and without limitation, display any type of information, such as map related information, navigation instructions, certain type of warning or alerts, automatic driving assistance information, vehicle's speed, fuel level, engine temperature, communication events, and other related information on the windshield 1205 of the vehicle 1200. The display of such information on the windshield 1205 of the vehicle 1200 may also be represented without limitation in any form, such as digital gauges, text boxes, animated images, or any other graphical representation. Further, the display system 1210 of the vehicle 1200 may also present augmented reality graphic elements which augment a physical environment surrounding the vehicle 1200 with real-time information.

The display system 1210 includes a display panel 1220 and a first multilayer optical film 1230. In the illustrated embodiment of FIG. 12B, the first multilayer optical film 1230 may be substantially similar to the multilayer optical film 10a of FIG. 11A. In other words, the first multilayer optical film 1230 may act as a reflective polarizer (such as the Samples A, B, C described with reference to FIG. 1A and the respective Tables 1, 2, 3). The display system 1210 further includes a second multilayer optical film 1240. In the illustrated embodiment of FIG. 12B, the second multilayer optical film 1240 may be substantially similar to the second multilayer optical film 10b of FIG. 11A. In other words, the second multilayer optical film 1240 may act as a mirror (such as the Samples D, E described with reference to FIG. 1A and the respective Tables 4, 5).

The display panel 1220 may include various elements, such as an electroluminescent panel, an incandescent or a phosphorescent light source, a cathode ray tube (CRT), light emitting diodes (LEDs), lenses, collimators, reflectors, and/or polarizers. In some embodiments, the display panel 1220 may include an organic light emitting diode (OLED) display panel. In some other embodiments, the display panel 1220 may include a liquid crystal display (LCD) panel. The virtual image 1212 can be substantially monochromatic, polychromatic, narrow band, or broad band, but preferably overlaps at least a portion of the visible spectrum. Furthermore, the display panel 1220 may also include a mechanism, such as a tilting mirror or displacement means, to change the angle and/or position of the virtual image 1212 so as to accommodate the passenger 1211 at different positions or heights.

The display panel 1220 is configured to emit a light 1221 polarized along a first direction. In some embodiments, the light 1221 includes at least one wavelength (e.g., the at least the first wavelengths 33, 34, 35) in the visible wavelength range (such as the visible wavelength range 151 of FIG. 3A) corresponding to at least one of blue, green, and red lights.

The first multilayer optical film 1230 is configured to receive and reflect the light 1221 as a first reflected light 1222. The first multilayer optical film 1230 may be configured to transmit at least a portion of the light 1221. The first reflected light 1222 is configured to be reflected toward the passenger 1211 after reflection from at least the windshield 1205 of the vehicle 1200. In some embodiments, the windshield 1205 is configured to receive and reflect between 5% to 40% of a second reflected light 1223 as a third reflected light 1227 toward the passenger 1211 of the vehicle 1200. In the illustrated embodiment of FIG. 12B, the second multilayer optical film 1240 is configured to receive and reflect the first reflected light 1222 as the second reflected light 1223 toward the windshield 1205 of the vehicle 1200, which forms the virtual image 1212 on the windshield 1205 of the vehicle 1200.

The multilayer optical films 10, 10a, 10b, 1230, 1240 may provide a high reflectance (e.g., greater than about 80%) for the incident lights 20a for at least the first wavelength 33, 34 in the first wavelength range 30, 31. In other words, the multilayer optical films 10, 10a, 10b, 1230, 1240 may provide a high reflectance (e.g., greater than about 80%) for the incident light 20a of a desired wavelength in the first wavelength range 30, 31.

This may be achieved by optimizing the refractive indices nx1, ny1, nz1, nx2, ny2, nz2, and thicknesses of the first and second polymeric layers 11, 12 to provide a suitable birefringence. Further, the multilayer optical films 10, 10a, 10b, 1230, 1240 may include materials that may not discolor due to prolonged exposure to UV light present in sunlight, such as polyethylene terephthalate (PET) in some cases.

Further, since the optical reflectance versus wavelength of the multilayer optical films 10, 10a, 10b, 1230, 1240 include sharp band edges, the multilayer optical films 10, 10a, 10b, 1230, 1240 may provide a high contrast.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A multilayer optical film comprising a plurality of alternating first and second polymeric layers numbering at least 50 in total, each of the first and second polymeric layers having an average thickness of less than about 500 nm, the first and second polymeric layers having respective indices of refraction nx1 and nx2 along a same in-plane first direction, 0.1≤nx1−nx2≤0.25 at at least one visible wavelength in a visible wavelength range extending from about 420 nm to about 680 nm, such that for a substantially normally incident light polarized along the first direction, the plurality of alternating first and second polymeric layers reflects greater than about 80% of the incident light for at least a first wavelength in a first wavelength range extending from about 380 nm to about 680 nm, and has an average optical absorbance of less than about 1% for a second wavelength range extending from about 380 nm to about 400 nm.

2. The multilayer optical film of claim 1, wherein the first and second polymeric layers have respective indices of refraction ny1 and ny2 along a same in-plane second direction orthogonal to the first direction, ny1−ny2≥0.1 at the at least one visible wavelength, such that for the substantially normally incident light polarized along the second direction, the plurality of alternating first and second polymeric layers reflects greater than about 70% of the incident light for the at least the first wavelength in the first wavelength range.

3. The multilayer optical film of claim 1, wherein the first and second polymeric layers have respective indices of refraction ny1 and ny2 along a same in-plane second direction orthogonal to the first direction, a magnitude of a difference between ny1 and ny2 less than about 0.05 at the at least one visible wavelength, such that for the substantially normally incident light polarized along the second direction, the plurality of alternating first and second polymeric layers transmits greater than about 60% of the incident light for the at least the first wavelength in the first wavelength range.

4. The multilayer optical film of claim 1, wherein for the substantially normally incident light polarized along the first direction, an optical reflectance of the plurality of alternating first and second polymeric layers versus wavelength comprises a reflection band edge along which the optical reflectance generally decreases with increasing wavelength, and wherein a best linear fit to the reflection band edge at least across a wavelength range along the reflection band edge where the optical reflectance decreases from about 70% to about 30% has a negative slope having a magnitude of greater than about 1%/nm.

5. The multilayer optical film of claim 1, wherein for the substantially normally incident light polarized along the first direction, the plurality of alternating first and second polymeric layers has an average optical absorbance ABS1 for the second wavelength range and an average optical absorbance ABS2 for a third wavelength range extending from about 380 nm to about 450 nm, ABS1/ABS2≤2.5.

6. The multilayer optical film of claim 1, wherein the first polymeric layers have an index of refraction nz1 along a same out-of-plane direction orthogonal to the first direction, and wherein 1.47≤nz1≤1.56 at the at least one visible wavelength.

7. The multilayer optical film of claim 1, wherein for a p-polarized incident light at an incident angle of at least 40 degrees in an incident plane that comprises the first direction, an optical reflectance of the plurality of alternating first and second polymeric layers versus wavelength comprises a reflection band edge along which the optical reflectance generally decreases with increasing wavelength, and wherein a best linear fit to the reflection band edge at least across a wavelength range along the reflection band edge where the optical reflectance decreases from about 70% to about 30% has a negative slope having a magnitude of greater than about 2%/nm.

8. A display system comprising:
an extended light source configured to emit a light from an emission surface thereof; and
first and second multilayer optical films of claim 1 disposed on opposite sides of the extended light source so that the first multilayer optical film generally faces the emission surface and the second multilayer optical film generally faces away from the emission surface, such that for the substantially normally incident light polarized along an in-plane second direction orthogonal to the first direction and for the at least the first wavelength in the first wavelength range, the plurality of alternating first and second polymeric layers:
of the first multilayer optical film transmits greater than about 60% of the incident light; and
of the second multilayer optical film reflects greater than about 60% of the incident light.

9. The display system of claim 8, wherein the emission surface and the second multilayer optical film are substantially parallel, and co-extensive in length and width, with each other, and the emission surface makes an angle of between about 20 degrees and 70 degrees with the first multilayer optical film.

10. A multilayer optical film comprising a plurality of alternating first and second polymeric layers numbering at least 50 in total, each of the first and second polymeric layers having an average thickness of less than about 500 nm, the first polymeric layers comprising a polyethylene terephthalate and having an index of refraction nx1 greater than an index of refraction nx2 of the second polymeric layers along at least a same in-plane first direction, such that for a substantially normally incident light polarized along the first direction, the plurality of alternating first and second polymeric layers reflects greater than about 80% of the incident light for at least a first wavelength in a first wavelength range extending from about 380 nm to about 680 nm, and has an average optical absorbance of less than about 1% for a second wavelength range extending from about 380 nm to about 400 nm.

11. The multilayer optical film of claim 10, wherein for the substantially normally incident light polarized along an in-plane second direction orthogonal to the first direction and for the at least the first wavelength in the first wavelength range, the plurality of alternating first and second polymeric layers reflects greater than about 60% of the incident light.

12. The multilayer optical film of claim 10, wherein for the substantially normally incident light polarized along an in-plane second direction orthogonal to the first direction and for the at least the first wavelength in the first wavelength range, the plurality of alternating first and second polymeric layers transmits greater than about 60% of the incident light.
